(19) United States
(12) Patent Application Publication
(10) Pub. No.: US 2015/0170238 A1
(43) Pub. Date: Jun. 18, 2015

(54) COMPUTERIZED RETAIL EXCHANGE SYSTEM AND METHOD

(71) Applicant: Joseph O'Malley, Chicago, IL (US)

(72) Inventor: Joseph O'Malley, Chicago, IL (US)

(21) Appl. No.: 14/199,077

(22) Filed: Mar. 6, 2014

Related U.S. Application Data
(60) Provisional application No. 61/917,582, filed on Dec. 18, 2013.

(51) Int. Cl. G06Q 30/06

(52) U.S. Cl. CPC G06Q 30/0611; G06Q 30/0625

(57) ABSTRACT

A method includes steps of receiving a plurality of search parameters through a network interface from a user computing device, the search parameters comprising an inventory item description, a price range, a location, and a distance range from the location; performing a search, via a processor, in a quote table stored in a memory for inventory items that meet the search parameters, the search results comprising at least one inventory item security identifier, a corresponding sale price, and a corresponding sale location; and sending the search results through the network interface to the user computing device. Also, a system having a processer; a memory connected to and in communication with the processor; and a network interface connected to and in communication with the processor; wherein the memory comprises a plurality of computer executable instructions stored therein that, in response to execution by the processor, perform the steps of the method.

### FIELD OF THE INVENTION

The present disclosure relates to a system and method for a retail exchange platform that provides customers and businesses the ability to use electronic exchange technology in making purchases of products and services.

### SUMMARY

The present invention relates to a method which includes the steps of receiving a plurality of search parameters through a network interface from a user computing device, the search parameters comprising an inventory item description, a price range, a location, and a distance range from the location; performing a search, via a processor, in a quote table stored in a memory for inventory items that meet the search parameters, the search results comprising at least one inventory item security identifier, a corresponding sale price, and a corresponding sale location; and sending the search results through the network interface to the user computing device.

The present invention further relates to a system which includes a processer; a memory connected to and in communication with the processor; and a network interface connected to and in communication with the processor; wherein the memory includes a plurality of computer executable instructions stored therein that, in response to execution by the processor, perform the steps of: receiving a plurality of search parameters through the network interface from a user computing device, the search parameters comprising an inventory item description, a price range, a location, and a distance range from the location; performing a search in a quote table stored in a memory for inventory items that meet the search parameters, the search results comprising at least one inventory item security identifier, a corresponding sale price, and a corresponding sale location; and sending the search results through the network interface to the user computing device.

### BACKGROUND

Many websites have been created to provide operational support to a store that offers goods and/or services for sale. The seller will typically post their web site on a server that will display items for sale and corresponding prices; take orders from customers; and process payments from the customers. The customer communicates its purchasing information from its computing device to the seller's server. For example, such a website could include a restaurant website, such as www.eat24.com, a discount product website, such as www.overstock.com, or a drug store website, such as www.walgreens.com, which all display their items along with their corresponding price. Live orders come in from customers and the customer's payments are processed.

There are also auction websites, such as, www.ebay.com, which will post an auction website on a server. An item will be listed on the website to be bid upon by potential buyers wherein a starting minimum bid price is listed with the item. A predetermined time for bidding is set. Buyers through their computing device that are in connection to this server send bids to the server to purchase the item. Typically, after the predetermined length of time has transpired, the bidding will be closed and the highest bid at that time, which is over the initial minimum bid price, purchases the item. The buyer's payment will be processed by a server.

There are also daily deal websites, such as www.groupon.com, which will post a notification of a discounted product or service that is available to their members on their website. The members can communicate with use of their computing device that is in connection with the server and take advantage of discounts and make the purchase(s).

Security exchanges such as NYSE, AMEX and ARCA also trade fungible products through their computerized systems. Offers are positioned on a server portraying the identity of the item, its price and the quantity and a bid is submitted by a buyer through a computer device in connection with the server wherein a sale or trade is automatically consummated when there is a match between the bid data and the offer data of the identity of the item, price and quantity.

A method for purchasing at least one of a product and service, which includes the steps of receiving information of at least one of a product and service from a seller and saving the information of the at least one of the product and service into a quote table; receiving a search request from a user, the search request including at least one required search parameter and at least one optional search parameter from a user; retrieving information from the quote table that matches the at least one required search parameter and the at least one optional search parameter; sending the information retrieved from the quote table to the user; receiving a purchase request from the user; and consummating a sale based on the purchase request.

### BRIEF DESCRIPTION OF DRAWINGS

FIG. 1 is a block diagram of an embodiment of a computerized retail exchange system;

FIG. 2 is a schematic representation of an example of a seller computing device as shown in FIG. 1;

FIG. 3 is a schematic representation of an example of a buyer computing device as shown in FIG. 1;

FIG. 4 is a schematic representation of an example of a web app manager server as shown in FIG. 1;

FIG. 5 is a schematic representation of an example of a mobile exchange server as shown in FIG. 1;

FIG. 6 is a schematic representation of an example of a quote server as shown in FIG. 1;

FIG. 7 is a schematic representation of an example of a clearinghouse server as shown in FIG. 1;

FIG. 8 is a schematic representation of an example of a risk server as shown in FIG. 1;

FIG. 9 is a schematic representation of an example of a configuration server as shown in FIG. 1;

FIG. 10 is an illustration of an example database server as shown in FIG. 1;

FIG. 11 is a flow chart of an example of uploading quotes;

FIG. 12 is a flow chart of an example of creating an exchange;

FIG. 13 is a flow chart of an example of searching and joining an exchange;

FIG. 14 is a flow chart of an example of purchasing from an exchange;

FIG. 15 is a flow chart of another example of creating an exchange; and

FIG. 16 is a flow chart of another example of purchasing from an exchange.

Before any independent features and embodiments of the invention are explained in detail, it is to be understood that the invention is not limited in its application to the details of the construction and the arrangement of the components set forth in the following description or illustrated in the drawings. The invention is capable of other embodiments and of being practiced or of being carried out in various ways. Also, it is understood that the phraseology and terminology used herein is for the purpose of description and should not be regarded as limiting.

### DETAILED DESCRIPTION

An example computerized retail exchange system can allow a buyer to sign up and communicate with the retail exchange system. A buyer could, in one instance, acquire a mobile application that would be downloaded and installed on a buyer's computing device, such as a smart phone. The buyer can then launch the mobile application and sign up for the computerized retail exchange system. At the time of launching the application, the application will direct the buyer to enter information about the buyer. The sign up could include the buyer providing identifying information such as the buyer's name, address, phone number(s), and credit card information in order for the system to be able to consummate a purchase by the buyer. Once a buyer has completed the task of signing up, the buyer will be able to interact with the computerized retail exchange system.

Once the buyer has signed up, he or she has a variety of operations that could be conducted. In one instance, a buyer could create an exchange with the submission of a search query, which could be for a particular product or service the buyer may be interested in purchasing that meets certain parameters of the buyer. The query could identify the product or service being considered by the buyer and also contain other filtering parameters, such as a quantity, a price or price limit, a particular seller, and/or a restriction that the product or service be within a certain distance from the buyer's location. In response to the query, the computerized retail exchange system could open an exchange and provide the buyer with a list of products/services that meet the filtering parameters set in the buyer's query.

In addition to the filtering parameters, the buyer can also provide a set of mandatory matching parameters that can be used to ensure that a product/service being sold by a seller matches the purchase requirements of the buyer immediately before the transaction is consummated.

Once the search results from the query are received, the buyer has a variety of options. One option is the buyer can review the results to get an idea of what is available and decide to close out the exchange that was opened for the query. Another option may be to select one of the listed products/services from the results of the query and consummate a purchase. If the buyer does not want to pay the price(s) quoted, yet another option may be to do nothing and leave the exchange open and see if any activity occurs within the open exchange. For example, sellers may alter their existing quotes within the open exchange or make a counter offer to the buyer. Alternatively, the buyer may take a more proactive approach and: (1) initiate an alteration of a parameter such as the buyer's original desired price parameter from the original query; or (2) provide a counteroffer to a specific seller for a product/service identified in the search results. If a parameter is altered, the buyer can then see if additional products/services are available based on the altered parameter. If a counteroffer is made and a seller matches the buyer's counteroffer, the system will consummate the sale. At any time, a seller can make a counter offer to a buyer based on the desired product/service and parameters. If there are counter offers from a seller(s) that still do not match a buyer's desired price or parameters, the buyer could select one of the counter offers and consummate a purchase, decide to make a responsive counter offer, do nothing, or close out the open exchange. Exchanges of counter offers between seller(s) and the buyer could lead to a price that is acceptable to the buyer and the seller, at which point the sale is then consummated by the system.

In addition to performing a product/service query and opening an exchange, a buyer could also submit a query for exchanges opened by others that have a particular product or service. This query could also specify a particular seller as a query parameter. The seller can then enter a resulting open exchange and operate similarly as if the buyer had opened the exchange, as described above. For example, the buyer can consummate a purchase, leave the exchange, or even make a counter offer within the exchange. In the instance of making the counter offer, a series of counter offers may occur between the seller and the buyer until a sale is consummated or the buyer decides to leave the exchange. Similarly, sellers can also sign up and join the computerized retail exchange system. A seller could use a computing device with, for example, a browser program to enter a website on the computerized retail exchange system. The seller could be asked information such as the name of the seller, the location of the seller, phone numbers and banking information regarding the seller so that retail exchange system can credit the seller's account when a sale is consummated.

Once a seller has signed up and joined the retail exchange system, the seller could utilize the computerized retail exchange system in a variety of ways. For example, the seller could list within the retail exchange system specific products and/or services offered for sale by the seller. Seller can list associated data which corresponds to the product/service it is offering, such as a particular price for the product and/or service, the quantity available from the seller, the location of the seller, etc. Other data may also be supplied as needed and requested by the retail exchange system. These listed offers of particular products and/or services by sellers along with the associated data are stored and made available to be searched when a buyer opens an exchange and submits a query.

In addition, sellers could also, for example, open their own exchange by offering particular products and/or services at particular prices, indicating quantity available, location, as well as, other information that may be required by the exchange system. Buyers, as mentioned above, could then access those open exchanges created by the sellers and search for open exchanges for a particular product or service and even elect to include a particular seller in their query. These searches or queries made by the buyer may also require, in one example, the sellers of these particular products and/or services be within a particular price range, the seller have sufficient quantity available, the seller be within a specified distance of buyer, etc. If matches for these queries occur, a buyer may enter the open exchange(s) and either accept the seller's offer, make a counter offer, or remove itself from that open exchange. If the buyer makes a counter offer, the seller may respond with another counter offer. If there is no match to the counter offer, this process can repeat itself within the open exchange such that a seller and a buyer could make successive counter offers until a price is met and a sale is consummated, the seller closes the exchange, or the buyer leaves the exchange.

Sellers could also search for and enter open exchanges within the retail exchange system that have been opened by buyers or other sellers. Sellers, at the time of locating an open exchange, could enter the open exchange and submit an offer, for example, so as to match the buyer's price position, possibly move closer to the buyer's position, move out of the open exchange or possibly do nothing at that time. In the instance of the seller altering the seller's price position and not matching the buyer's price position, this action may precipitate further action by the buyer. The offers and counter offers by the seller and buyer may lead to any number of results such as a consummation of a sale, no consummation of a sale, or one or both parties remove themselves from the open exchange.

A seller could also make queries into the retail exchange system and obtain competitive market data. For example, seller may submit a query to inquire about products and/or services offered by other sellers on the retail exchange system and obtain information about the products and/or services offered by the other sellers and associated data that the other sellers provided in association with that offered product or service. This kind of market study can be conducted by a seller to assist the seller in making decisions that may improve that seller's ability to make more sales.

Seller may also be able to track and look at the sales the seller has made, which could provide valuable information to assist the seller in managing deliveries and pick-ups, or to track what open offers the seller has in what open exchange. This latter information could enable a seller to be to be proactive about offers he or she has that are outstanding in open exchanges. For example, the seller could evaluate the open offers it has in various open exchanges and decide to leave the offers open, make a counter offer, or even to leave or close an open exchange.

In short, the computerized retail exchange system could provide utility and versatility for both buyers and sellers in a retail market. Each could have tools to search the market, consummate a sale, commence an open exchange, and enter into an open exchange wherein a bidding process may take place. Both buyers and sellers may be able to withdraw from or close an open exchange as well.

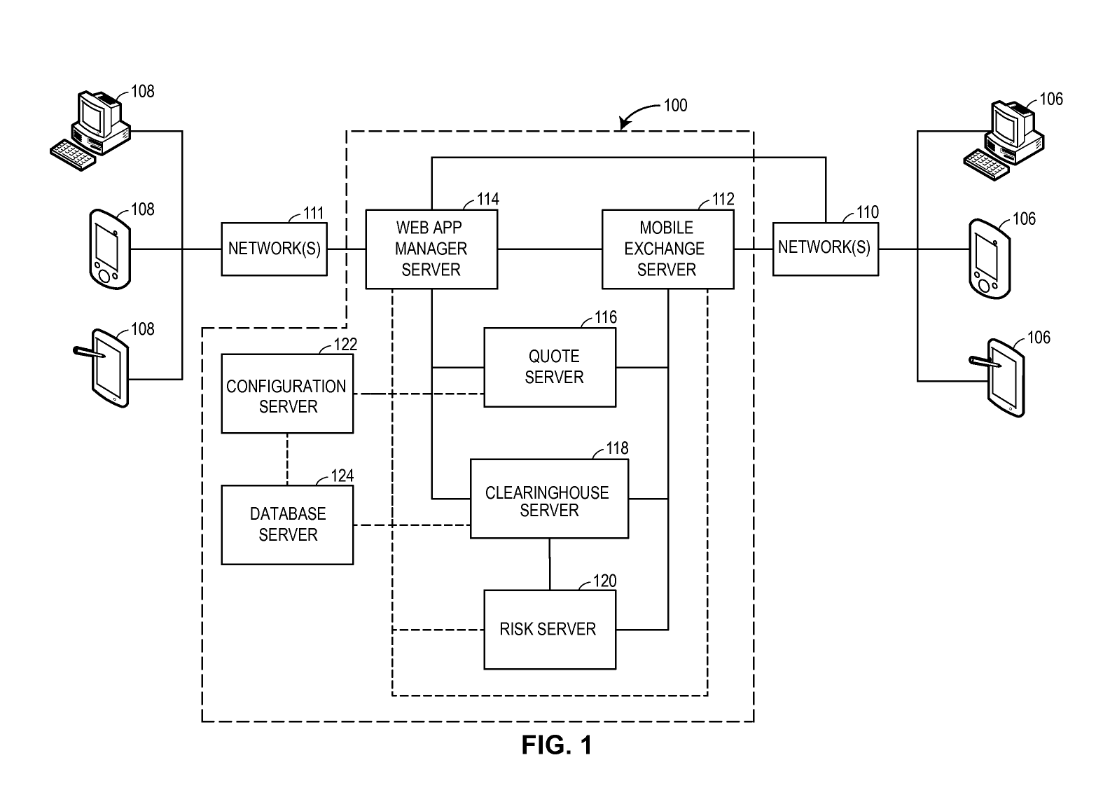

One specific example of a computerized retail exchange system 100 is shown in FIG. 1. In the example shown, computerized retail exchange system 100 communicates with at least one buyer computing device 106 through a network 110 and with at least one seller computing device 108 through network 111. While three buyer computing devices 106 and three seller computing devices 108 are shown, it will be understood that any number of buyer and seller computing devices 106, 108 could communicate with computerized retail exchange system 100 at any given time through any number of networks 110, 111. Buyer and seller computing devices 106 and 108 could comprise a wide variety of devices, such as desk top computers, lap top computers, tablets, smart phones and the like. Similarly, networks 110, 111 could be a variety of network types such as the Internet, a LAN, a WAN, cellular, WiFi, etc.

In the example shown in FIG. 1, computerized retail exchange system 100 includes a mobile exchange server 112, a web app manager server 114, a quote server 116, a clearinghouse server 118, a risk server 120, a configuration server 122, and a database server 124. Although multiple separate servers are shown in FIG. 1, it will be understood by those skilled in the art that retail exchange system 100 could include a single server that performs all of the functions described below or could be divided into any number of servers as desired.

In the example shown, mobile exchange server 112 is in communication with buyer computing devices 106 through network(s) 110 and with other servers within computerized retail exchange system 100, such as web app manager server 114, quote server 116, clearinghouse server 118, risk server 120, configuration server 122, and database server 124.

Web app manager server 114 is also in communication with buyer computing devices 106 through network(s) 110, with seller computing devices 108 through network(s) 111, and with other servers within computerized retail exchange system 100, such as quote server 116, clearinghouse server 118, configuration server 122, database server 124 and, as mentioned above, mobile exchange server 112.

In the example shown in FIG. 1, configuration server 122 communicates with all of the servers within system 100, including mobile exchange server 112, web app manager server 114, quote server 116, clearinghouse server 118, risk server 120, and database server 124. Similar to configuration server 122 above, database server 124 also communicates with all of the servers in system 100. Clearinghouse server 118 also communicates with risk server 120.

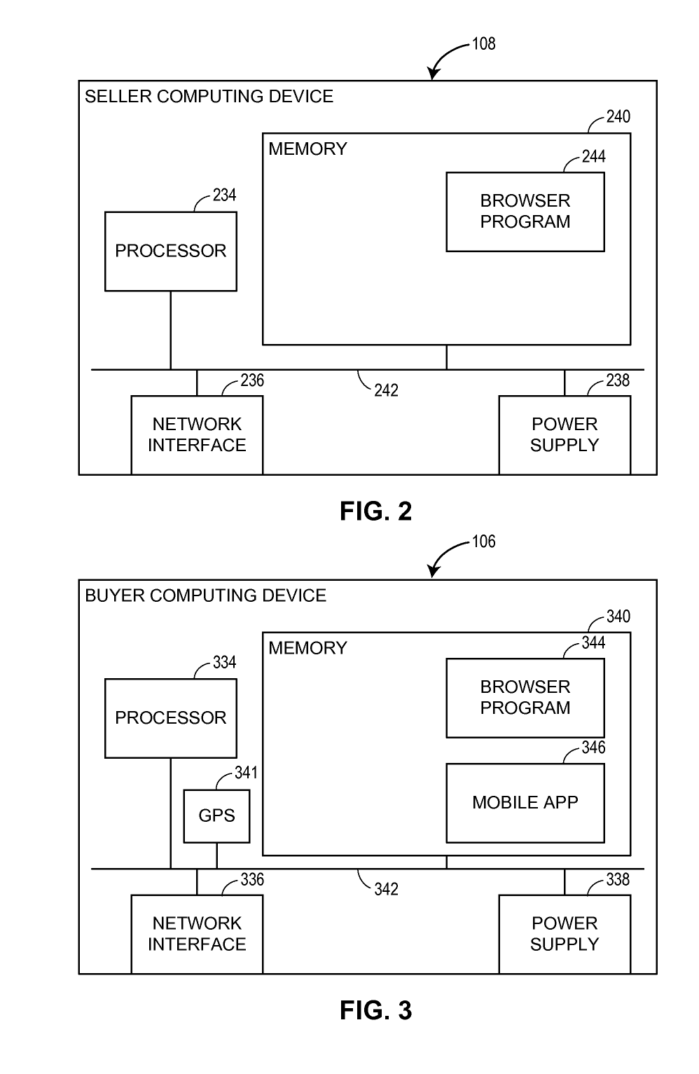

Referring to FIG. 2, a schematic representation of an example seller computing device 108 is shown. As discussed above, seller computing device 108 could be a wide variety of devices, such as a desk top computer, a lap top computer, a tablet, a smart phone and the like, but will generally include a processor 234, at least one network interface 236, a power supply 238, and memory 240, all interconnected by a power bus 242. Memory 240 includes, in this example, a browser program 244, which can be any browser software that will allow a seller to access the Internet, such as Chrome®, Firefox®, Internet Explorer®, Opera®, Safari®, or others. Browser program 244 permits a seller to communicate with web app manager server 114 of retail exchange system 100 through network(s) 111, as discussed in more detail below.

Referring to FIG. 3, a schematic representation of an example buyer computing device 106 is shown. As discussed above, buyer computing device 106 could be a wide variety of devices, such as a desk top computer, a lap top computer, a tablet, a smart phone and the like, but will generally include a processor 334, at least one network interface 336, a power supply 338, memory 340, and a global positioning system (GPS) receiver 341, all interconnected by a power bus 342. Memory 340 includes mobile app 346 and browser program 344, which can be any browser software that will allow a buyer to access the Internet, such as Chrome®, Firefox®, Internet Explorer®, Opera®, Safari®, or others. In this example, browser program 344 permits a buyer to communicate with mobile exchange server 112 and web app manager server 114 of retail exchange system 100 through network(s) 110. In the example shown, mobile app 346 is a program that can be used by a buyer to communicate with mobile exchange server 112, however, it will be understood by those skilled in the art that mobile app 346 is optional and that all of the functionality described below could be implemented with a buyer accessing retail exchange system 100 via a mobile app 346 or a browser program 344. GPS receiver 341 provides buyer computing device 106 with data as to the location of the device 106. This data can be used in providing matches to the buyer with respect to queries that are initiated by buyer for requested products or services that are within a certain distance from computing device 106. The schematic shown in FIG. 3 provides an example of how a buyer can communicate with system 100 using a computing device and it should be appreciated by those skilled in the art that other common communication configurations may be employed.

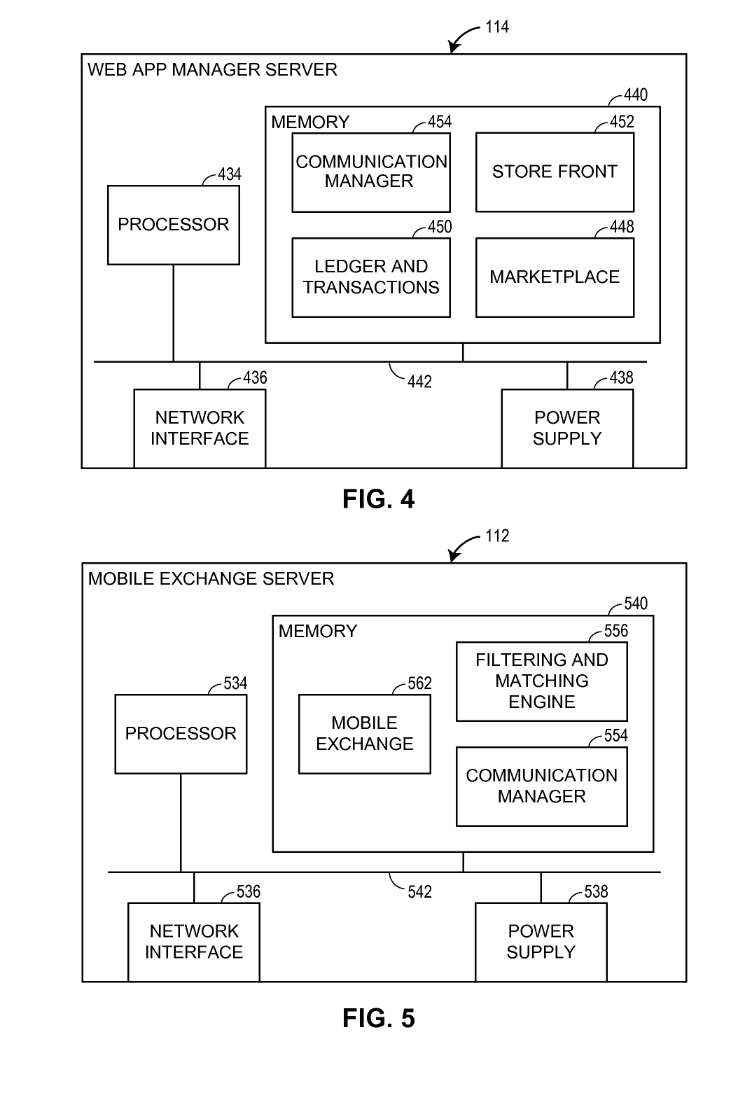

Referring to FIG. 4, a schematic representation of an example web app manager server 114 is shown. Web app manager server 114 generally includes a processor 434, at least one network interface 436, a power supply 438, and memory 440, all interconnected by a power bus 442. Memory 440 stores various software modules, such as a store front module 452, a marketplace module 448, a ledger and transactions module 450, and a communication manager module 454. These modules each include computer-executable instructions that, in response to execution by processor 434, cause processor 434 to perform the operations described in more detail below. For example, store front module 452 can allow a seller to upload its inventory of products or services, otherwise referred to as inventory items. Each item listed can be accompanied by associated data and will be discussed in more detail below. Seller can access storefront module 452 through computing device 108 to upload its inventory items, edit the inventory items, or add and delete inventory items as seller chooses.

Marketplace module 448 can allow a seller and/or buyer to perform various analytics within system 100. These analytics could include, for example, a seller presenting a query regarding the sale price of a particular item (product/service) that is being offered for sale within a certain distance of the seller; a buyer presenting a query regarding open exchanges of a particular seller that is offering a particular product or service within a certain distance from buyer's computing device 106; or a seller presenting a query to locate and view open exchanges. Marketplace module 448 can also allow a seller to submit price changes into an open exchange or make counter offers in open exchanges. Additionally, marketplace module 448 can allow a seller to open its own exchange for its own products and/or services.

Ledger and transactions module 450 can allow a seller to view consummated sales of their products or services that have transpired through the operation of retail exchange system 100. The seller may also be able to see when the consummated sale took place and the expected time for pick-up or expected time for delivery of the product/service that was sold. Additionally, seller may be able to view open offers the seller has in open exchanges and be able to edit or cancel such open offers.

Communication manager module 454 can function as the communications program between web app manager server 114 and other servers in retail exchange system 100.

Referring to FIG. 5, a schematic representation of an example mobile exchange server 112 is shown. Mobile exchange server 112 generally includes a processor 534, at least one network interface 536, a power supply 538, and memory 540, all interconnected by a power bus 542. Memory 540 stores various software modules, such as a communication manager module 554, a filtering and matching engine module 556, and a mobile exchange module 562. These modules each include computer-executable instructions that, in response to execution by processor 534, cause processor 534 to perform the operations described in more detail below. For example, communication manager module 554 can function as the communications program between mobile exchange server 112 and other servers in retail exchange system 100.

Filtering and matching engine module 556 can compare the mandatory matching parameters indicated when the exchange was created to determine if the sale should be consummated. Mobile exchange module 562 creates and manages the open exchanges set up by a buyer making a query or set up by a seller.

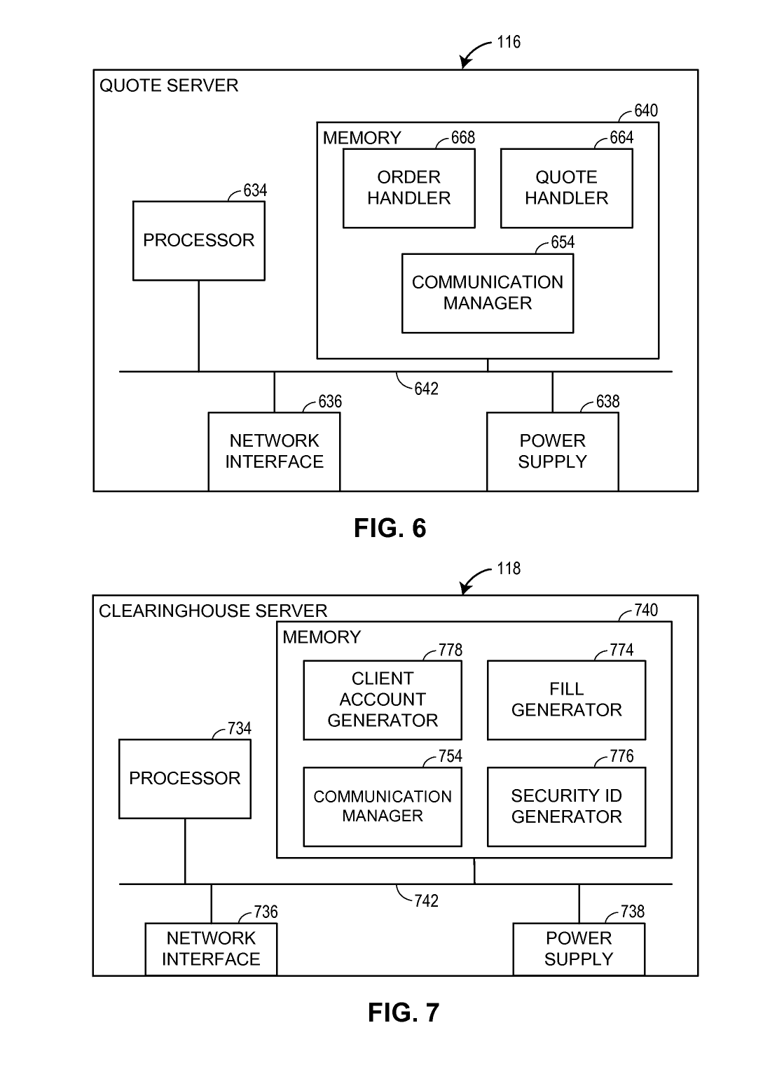

Referring to FIG. 6, a schematic representation of an example quote server 116 is shown. Quote server 116 generally includes a processor 634, at least one network interface 636, a power supply 638, and memory 640, all interconnected by a power bus 642. Memory 640 stores various software modules, such as a quote handler module 664, an order handler module 668, and a communication manager 654. These modules each include computer-executable instructions that, in response to execution by processor 634, cause processor 634 to perform the operations described in more detail below. For example, quote handler module 664 can receive buyer/seller queries about products and/or services available through retail exchange system 100 and perform searches based on those queries. Order handler module 668 can receive data regarding a seller's inventory he or she chooses to offer for sale. Communication manager module 654 can communicate with other servers within system 100.

Referring to FIG. 7, a schematic representation of an example clearinghouse server 118 is shown. Clearinghouse server 118 generally includes a processor 734, at least one network interface 736, a power supply 738, and memory 740, all interconnected by a power bus 742. Memory 740 stores various software modules, such as a fill generator module 774, a security ID generator module 776, a client account generator module 778, and a communication manager module 754. These modules each include computer-executable instructions that, in response to execution by processor 734, cause processor 734 to perform the operations described in more detail below. For example, fill generator module 774 can receive and record the details of consummated sales. Security ID generator module 776 can create identification information, such as a value or other identifier that is associated with a specific product or service. Often this identification can be a bar code value, Universal Product Code (UPC), or other identifier. If a product or service does not have already a security ID, a security ID can assign an identifier through security ID generator module 776. Client account generator module 778 can request and receive information from a buyer or seller and use this information to create an account for the buyer/seller on system 100. Communication manager 754 communicates with other servers within system 100.

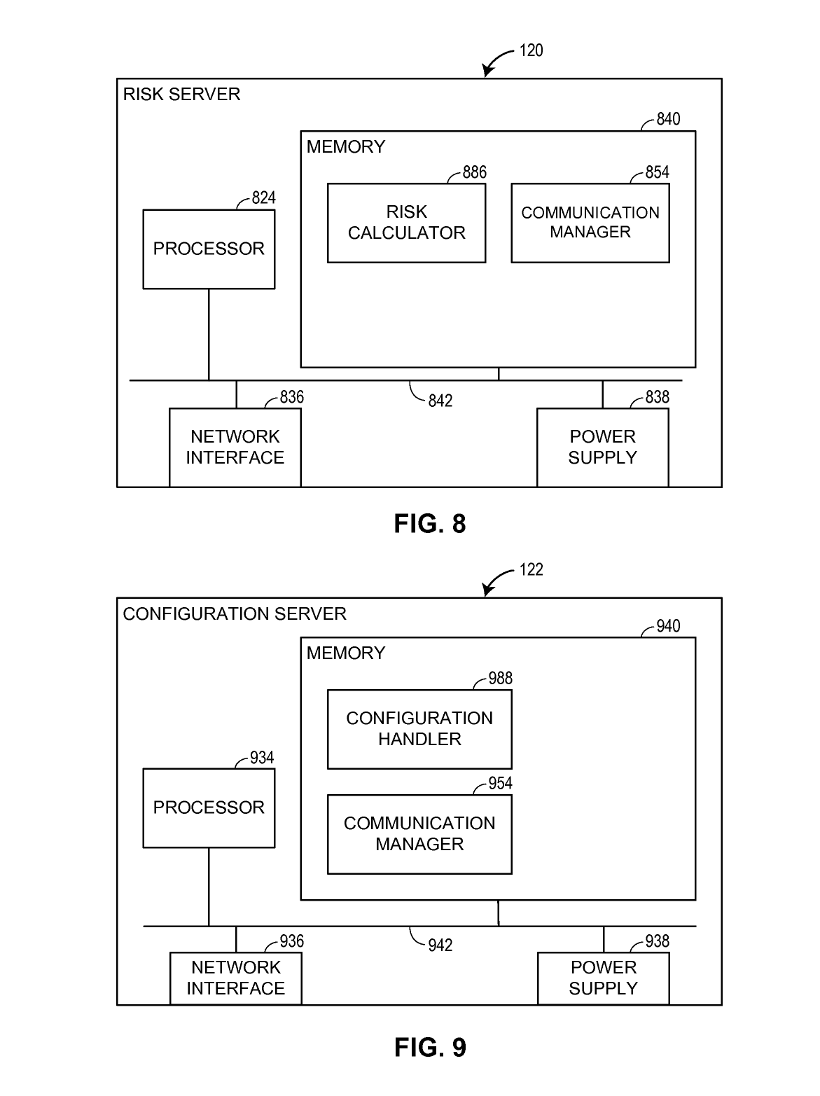

Referring to FIG. 8, a schematic representation of an example risk server 120 is shown. Risk server 120 generally includes a processor 834, at least one network interface 836, a power supply 838, and memory 840, all interconnected by a power bus 842. Memory 840 stores various software modules, such as a risk calculator module 886 and a communication manager module 854. These modules include computer-executable instructions that, in response to execution by processor 834, causes processor 834 to perform the operations described in more detail below. For example, communication manager module 854 communicates with other servers in system 100. Risk calculator module 886 can be used to limit the risk of mistakes and theft within the operation of system 100. Risk calculator modules are well known and can be used to attempt to prevent a consummation of a sale should a “fat finger” event take place, possibly generating too large of orders, for example.

Referring to FIG. 9, a schematic representation of an example configuration server 122 is shown. Configuration server 122 generally includes a processor 934, at least one network interface 936, a power supply 938, and memory 940, all interconnected by a power bus 942. Memory 940 stores various software modules, such as a configuration handler module 988 and a communication manager module 954. These modules each include computer-executable instructions that, in response to execution by processor 934, cause processor 934 to perform the operations described in more detail below. Communication manager module 954 communicates with other servers within system 100. Configuration handler module 988 can be used to make changes to operating criteria within each server. Some examples could include defaults for queries, such as for quantity; permission settings for access into system; language used on system; text font used on system; visual appearance of web pages; data required for queries and for quotes, a buyer's/seller's risk setting, etc.

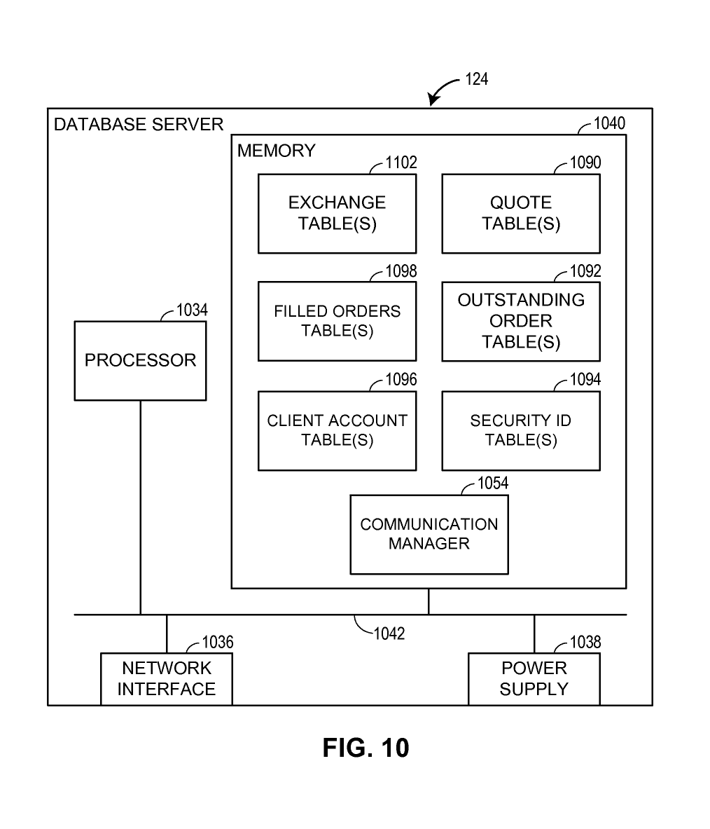

Referring to FIG. 10, a schematic representation of an example database server 124 is shown. Database server 124 generally includes a processor 1034, at least one network interface 1036, a power supply 1038, and memory 1040, all interconnected by a power bus 1042. Memory 1040 stores various software modules, such as communication manager module 1054. These modules each include computer-executable instructions that, in response to execution by processor 1034, cause processor 1034 to perform the operations described in more detail below. Communication manager module 1054 communicates with other servers within system 100. Memory 1040 can also include a relational database or other type of database or memory map having a variety of tables, such as a quote table(s) 1090, an outstanding order table(s) 1092, a security ID table(s) 1094, a client account table(s) 1096, a filled order table(s) 1098, and an exchange table(s) 1102. Quote table(s) 1090 can include information related to inventoried items from sellers who have uploaded the items and their respective corresponding data. For example, the data associated with each inventory item uploaded could include a product/service identification (“ID”), which could be a unique identifier that is assigned to each specific product/service, a security ID, which could be a barcode value or a Universal Product Code or “UPC” designation, a product description, the price at which a particular seller is offering the product/service, product/service location information, and the quantity or number of units being offered by a particular seller. The associated data described herein for uploading with each inventory item is merely exemplary and other associated data related to inventory item may be included as desired. Outstanding order table(s) 1092 can include all information within all of the open exchanges within system 100, such as information related to buyers' unmatched bids for a product or service and sellers' outstanding counter offers. Security ID table(s) 1094 can include product and service identification values. Client account table(s) 1096 can include client information from buyers and sellers. This information could include names, addresses, telephone numbers, credit card information and banking information. Filled order table(s) 1098 can include data of consummated sales, such as the pertinent data of the consummated sale including identity of seller and buyer, price paid, quantity purchased, banking and credit card information, as well as, time and date of the sale. Exchange table(s) 1102 can include data from exchanges that have been opened.

Various embodiments of methods of operating computerized retail system 100 will now be discussed. The first method of operation of system 100 to be addressed involves an embodiment of seller's method of listing products and/or services, or also referred to hereafter as, inventory items or quotes, which seller wishes to offer for sale within system 100, as well as a seller's method for editing inventory items or quotes the seller has previously listed for sale within system 100.

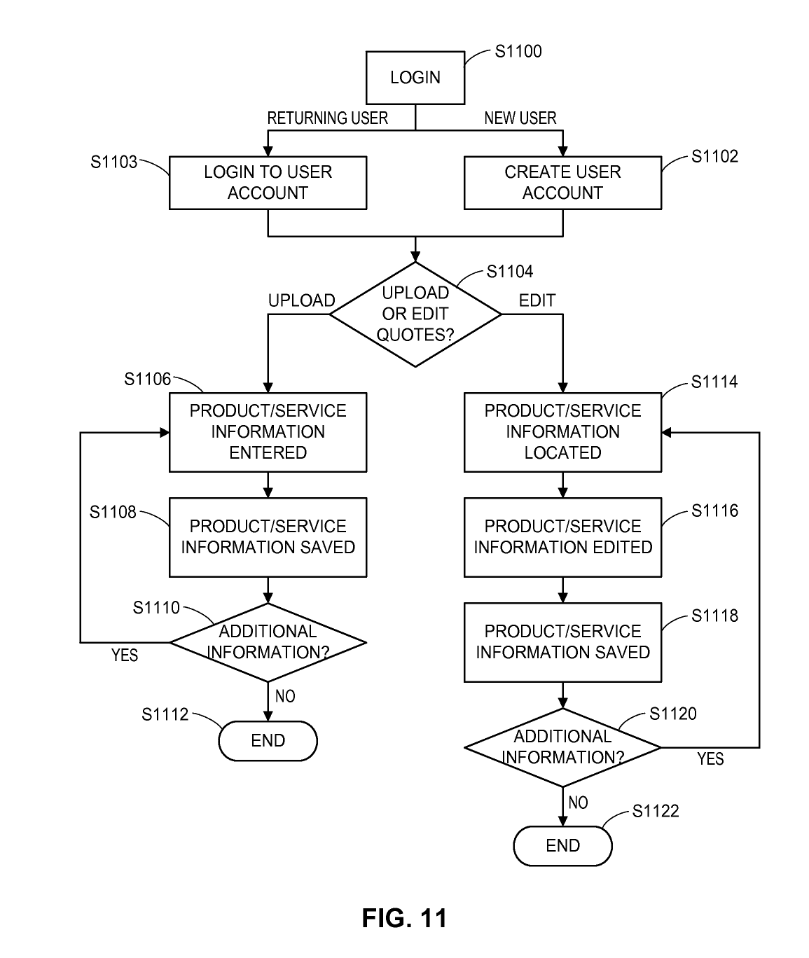

An embodiment of a method for a seller to list inventory items for the first time within system 100 and to edit previously listed inventory items is shown in flowchart shown in FIG. 11. A seller must first log into system 100 at step S1100. A seller, in this embodiment, through use of its computing device 108 and browser 244, accesses communication manager 454 module on web app manager server 114. Communication manager 454 module communicates to communication manager 754 on clearing house server 118 resulting in communicating to client account generator module 778 that a potential user is contacting system 100. Client account generator module 778 transmits a web page through communication manager 754 to communication manager 454 and displays that web page to seller. The web page displayed will ask the potential user/seller if they are a new user or if they are already a member user of system 100. If user, and in this instance seller, responds that it is a new user, that information is transmitted from communication manager 454 to communication manager 754 on clearinghouse server 118 which notifies client account generator module 778 that a new client account must be generated for this new user. Client account generator module 778 will communicate back with use of communication manager 754 to communication manager 454 presenting the new incoming user/seller a web page that will ask the seller for information in order to create a new user/seller account for system 100 at step S1102.

The new user/seller at step S1102 will be asked on the web page presented, to fill in answers to certain questions. In this embodiment, the new user/seller will be asked to provide information to create a new account for this user/seller to be able to operate within system 100. Some of the information will be mandatory to create an account and be able to operate within system 100 and possibly other information may be designated optional for creating an account and being able to operate within system 100. In this embodiment, the information requested would include: a franchise identification number; a store identification number, the store owner; store manager's name; whether it is a physical store or internet store; industry in which the seller operates; store location; telephone number; e-mail address, etc. Additionally, the new incoming seller will be asked to provide bank account information and to create a password. The banking information that was uploaded will be used by system 100 for crediting seller's account when an inventory item, product or service, of the seller is sold in system 100.

The uploaded information by the applicant new seller is then transmitted back through communication manager 454 to communication manager 754 on clearing house server 118 and the information that was submitted is forwarded to client account generator module 778. This information is reviewed by an account manager/administrator of system 100. Should the prospective new user/seller meet approval by the reviewer, the reviewer assigns a client account number to the prospective new user and transmits the data from new client generator 778 module to communication manager 1054 by way of communication manager 754 and onto client account table(s) 1096. The administrator will also transmit a communication from client account generator 778 through communication manager 754 to communication manager 454 indicating to prospective user/seller they have been approved to work with system 100 along with providing them with their newly assigned client account number. At this point, the prospective new/user is now a new client registered to system 100 and will be able to operate within system 100 with a pass word and client account number.

The newly registered seller can now enter into system 100 by using its computing device 108 and with providing the web page provided to the user at the time of login and the user identifying it is a registered user. The web page will ask the user to provide its client account number and their password. The method will be discussed below with respect to a registered user accessing any of three application modules on web app manager server 114. These modules include store front module 452, marketplace 448 and ledger and transactions 450. From these three application modules the user/seller will operate in an embodiment of this system 100.

When the user is logging in at step S1100 and is already a registered user of system 100, the user will identify on the web page they are already a member. The web page will ask the user to provide its client account number and password. In the step of login to user account S1103 the user will enter its client account number and password. The password and client account number entered are transmitted from the communication manager 454 module to communication manager 754 on clearinghouse server 118 and from there to client account generator module 778. Client account generator 778 conducts a search through communication manager 754 communicating with communication manager 1054 on database server 124 wherein client account table(s) 1096 are searched. If the search identifies a match to the provided pass word and client account number in client account table(s) 1096, the match is identified to client generator 778 module from the data searched in client account table(s) 1096, client generator 778 module transmits acknowledgement of the match to communication manager 754 to communication manager 454 on web app manager server 114 that the pass word of a registered user has been located thereby communicating to the user the permission for the user/seller to access to system 100. Access to system 100 for the seller, is providing to the seller links to the three application modules carried by web app manager server 114. These three application modules include storefront 452, marketplace 448 and ledger and transactions 450. At this point, a previously registered user/seller has access to use and to operate within system 100.

With user/seller properly logged in, seller can, in this embodiment, click on a link or icon that will open storefront 452 module. With storefront 452 module opened, the seller will be asked by a web page of storefront 452 module whether the seller wishes to upload new inventory items or quotes or edit existing inventory items or quotes, in step S1104. If the response by the seller is “new”, the storefront 452 module will then proceed to request data about the product or service the seller wishes to newly list or quote within system 100. Some of the data requested may be mandatory and other data may be optional for the seller to provide to system 100. In this embodiment, storefront 452 will request seller to enter information into fields it has provided within step S1106. The data for each item entered will, in this embodiment include: the client account number that has already been assigned to that seller; a security identification number that identifies a particular product or service being offered; text description of the product or service; the quoted price for that product or service; location of the store of the seller and the quantity of the product/service that is available for sale. We will further discuss below each of these data items that will be associated with each inventory item or quote of the seller.

The user seller in this embodiment will be asked by the web page to provide its client account number. The user will at step S1106 enter this number which was assigned to them at the time the user/seller first registered into system 100, described above.

In this embodiment, the next information requested of the seller is to provide in step S1106 is the security identification number that is associated with that specific product or service they are listing. It should be noted that each item listed within system 100 carries a specific security identification number for that item. In one instance, the seller will know the security identification number that is associated with the particular item they are listing and enter it at this time. They will, for this embodiment, use the number from the bar code which is assigned from a Universal Product Code (UPC). With that number entered, storefront 452 will transmit it through communication manager 454 to communication manager 754 on clearinghouse server 118 to security identification generator 776 module. Security ID generator 776 module will search security ID table(s) 1094 on database server 124 through communication manager 754 and communication manager 1054. Security ID table(s) 1094 contain uploaded security identification information of products/services and their corresponding identification number. If the security identification number is located in security ID table(s) 1094 the match is identified and security ID generator module 776 transmits through communication manager 754 to communication manager 454 on web app server 114 and displays the product description associated with that security identification number provided by user/seller. At that point, user/seller can determine if that is in fact the product he or she is listing. If it is a correct description, user/seller can confirm entering the security identification number into the store front module 452 web page request. If no identification number was matched from security ID table(s) 1094 the security ID generator 776 module will transmit a communication to store front module 452 through communication managers 754 and 454 that no match occurred. The web page at store front module 452 could then provide user/seller the opportunity to resubmit the identification number to check if the match could be made but for a possible miss-entering of the security ID number by the user/seller or the user/seller could be asked to provide a description of the product/service and that information will be transmitted by way of communication managers 454 and 754 to security ID generator module 776 on clearinghouse server 118. At that point, security ID generator module 776 can assign an identification number to that description and forward, through communication managers 754 and 1054, the description and the newly assigned number to security ID table(s) 1094 on which that data is then uploaded and stored. Security ID generator module 776 can then transmit the newly assigned security identification number to store front module 452 through communication managers 754 and 454 and populate the web page on store front module 452 with the newly assigned identification number.

In a circumstance the user/seller does not have the security identification number for the product or service item they are listing in store front module 452, store front module 452 will request the user/seller to search system 100 for the correct security identification number. Store front module 452 will provide user/seller with an option to search for the security ID. The web page will request user/seller to type in a description of the product or service which in turn will be transmitted to security ID generator module 776 through communication managers 454 and 754. Security ID generator module 776 will then conduct a search of the descriptions of the products and services listed within security ID table(s) 1094 though communication managers 754 and 1054. The entries in security ID table(s) 1094 that closely match the description provided by user/seller are sent back to security ID generator module 776 through communication managers 1054 and 754. In turn, security ID generator module 776 communicates the entries that were located to store front module 452 through communication managers 754 and 454. User/seller is then displayed these entries and if one is the item that he chooses to list, the user/seller at that point can enter the security identification number into the store front module 452. As will be appreciated, populating store front module 452 with the proper security identification number is very important to the operation of system 100 so as to properly identify the product or service being offered for sale.

In addition to the information uploaded for the item as to the identification of the seller and the security identification of the product/service, the seller will be requested through a web page generated by store front module 452 to enter a short description of the product/service; the price the product/service is being offered, the store's location and the quantity the seller is indicating as available to be sold, etc. With respect to the price being entered by the user/seller, the web page in this embodiment will provide the user/seller a selection to indicate the life of that price such as: “good for the day’; or “good until cancelled”. Additionally, the location of the store, in this embodiment, can be entered as global positioning system data.

It is understood the data requested by the store front module 452 may vary from embodiment to embodiment, however, the information once populated on the web page of store front module 452 should then be saved as set forth in step S1108, as seen in FIG. 11. Thus, with the screen on the web page populated with the data for listing a particular item of user/seller, the user/seller can then instruct on the web page that the data to be saved. With the instruction given by the user/seller the data is then transmitted to quote handler module 664 quote handler module 664 on quote server 116 through communication managers 454 and 654. Quote handler module 664 quote handler module 664 takes that data and transmits the listed data to quote table(s) 1090 through communication managers 654 and 1054 and the data is uploaded onto quote table(s) 1090.

With each listing being saved onto quote table(s) 1090 at step S1108, the user/seller will be asked, as next step S1110, on store front module 452 module, whether another item is to be listed. If the user/seller answers “yes”, another web page is displayed to user/seller on store front module 452 module to enter another listing item and user/seller would repeat the steps of S1106 and S1108. Items will continue to be entered into system 100 until user/seller has completed listing its desired inventory. If user/seller answers “no” to store front module 452 web page at step S1110, that it does not have any more items to list at this time, store front module 452 module web page will end as step S1112 and close.

Still referring to FIG. 11, at step S1104 the user/seller is provided the choice of adding a new inventory item or to edit an existing inventory listing. Should the user/seller select to edit an existing listing that is being stored as described above in quote table(s) 1090 on database server 124, the web page from store front module 452 module will request information from the user/seller to identify the item. In this embodiment, the web page could request user/seller for their client identification number and the security identification number for the item listed. With the security identification number populated into the web page prompt, the user/seller could send the information to quote handler module 664 quote handler module 664 on quote server 116 through communication mangers 454 and 654 such that quote handler module 664 searches quote table(s) 1090 on database server 124 through communication managers 654 and 1054. Quote handler module 664 locates all items listed in quote table(s) with the client account number and the security identification number entered by the user/seller. The resulting data of those identified items within quote table(s) 1090 is transmitted through communication managers 1054 and 754 to quote handler module 664 quote handler module 664. Quote handler module 664 quote handler module 664 transmits these located items to storefront module 452 through communication managers 654 and 454 wherein the located data is displayed to user/seller. At this point, in step S1116 user/seller can make the appropriate edits to each item(s) that it chooses. User/seller can, through store front module 452, save this newly edited data in step S1118 by indicating the same at a web page generated by store front module 452. The edited inventory item data is retransmitted to quote handler module 664 on server 116 through communication managers 454 and 654. Quote handler module 654 then uploads and replaces the original data of the item that was stored and saved in quote table(s) 1090 on database server 124 with the newly edited inventory item. At this point an inventory item has now been edited within system 100.

At this point, user/seller has edited an inventory item on quote table(s) 1090 and has saved the edited item. Store front module 452 requests user/seller if it has additional inventory items to edit at step S1120. If the user/seller answers “yes”, store front module 452 presents user/seller another web page to identify an additional item in step S1114 and steps S1114, S1116 and S1118 are repeated again. This process continues until the user/seller answers the question at step S1120 “no”. At that point, the store front module 452 concludes prompting user/seller any further and closes out of store front module 452.

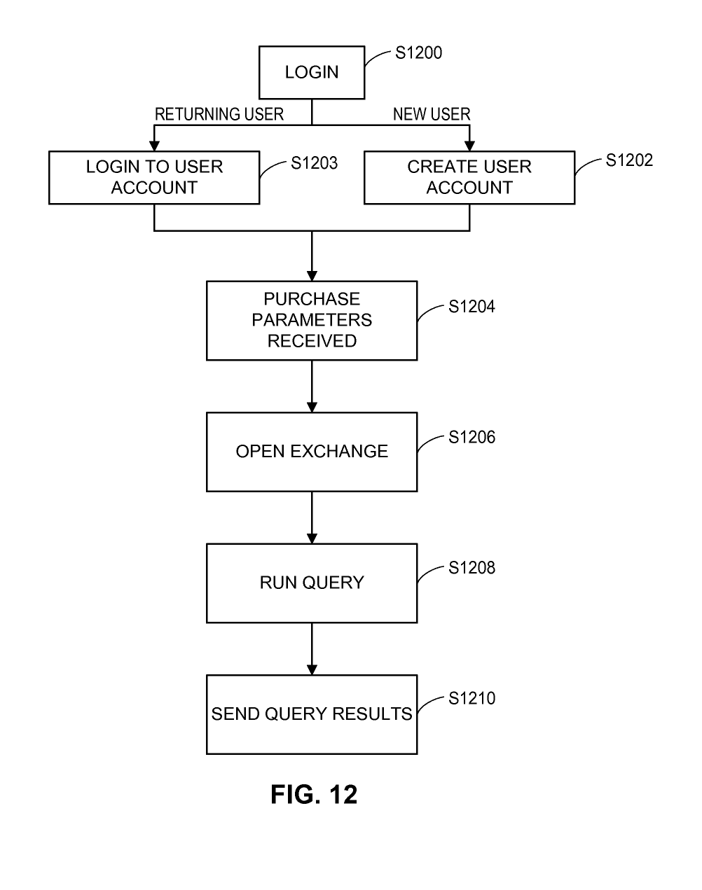

Referring now to FIG. 12, it shows an embodiment of a method for a buyer/user of system 100 to conduct a query or search with respect to a product or service they may wish to purchase and to create an exchange for that product or service. A buyer at this point will need to log into system 100 at step S1200.

In this embodiment, user/buyer will utilize their computing device 106 and in one instance use browser 344 and in another instance they could use mobile app 346. At step S1200 where the user/buyer will be logging into system 100 and using browser 344, user/buyer accesses communication manager 454 module which communicates with client account generator module 778 through communication manager 754. Client account generator module 778 transmits a web page to mobile exchange 562 through communication managers 754 and 554 and displays it to user/buyer. The web page will ask the potential user/buyer if they are a new user or if they are already a member user of system 100. If user/buyer responds that it is a new user they are asked to create a new account at step S1202 and if they respond they are a registered user they login to user account at step S1203.

Similarly, if the user/buyer has a mobile app 346, the mobile app will display a screen for logging into system 100 at step S1200. The user will be asked if they are a new user or whether they are a registered user. If they answer they are a new user they will be asked to create a new account at step S1202 and if they answer they are a registered user they will asked to login to their user account at step S1203.

In the instance the user/buyer utilizing its browser and responds that it is a new user/buyer, this information will be sent to client account generator module 778 through communication managers 454 and 754. Client account generator module 778 will send a web page to user/buyer through communication managers 754 and 454 asking user/buyer to provide information in order to create a new user/buyer account for system 100 at step S1202. In the instance of a new user/buyer using mobile app 346 and they respond to the screen displayed that they are a new user/buyer, the screen will proceed to ask them to provide information in order to create a new user/buyer account for system 100 at step S1202.

In either instance of utilizing browser 344 or mobile app 346, the new user/buyer will provide, in this embodiment, information such as: the name of the buyer; the address of the buyer; the phone number of the buyer; the e-mail address of the buyer etc. Additionally, the new incoming user/buyer will be asked to provide banking account information such as the identification of a particular credit card account and to create a password. The banking information or credit card information that was uploaded will be used by system 100 for debiting buyer's credit card account when the buyer purchases an inventory item, product or service, from system 100. Additionally, the new user/buyer will be asked to create a password for purposes of future accessing of system 100.

The personal information, in the instance of using browser 344, will be submitted through communication managers 454 and 754 to client account generator module 778 and is reviewed by an account manager/administrator of system 100. Should the prospective new user/buyer meet approval by the reviewer, the reviewer assigns a client account number to the prospective new user/buyer and transmits the data from new client account generator module 778 to communication manager 1054 by way of communication manager 754 and into client account table(s) 1096. The administrator will also transmit a communication from client account generator module 778 through communication manager 754 to communication manager 454 indicating to prospective user/buyer they have been approved to work with system 100 along with providing them with their newly assigned client account number. At this point, in this embodiment, step S1202 of creating a user account has been completed. The prospective new user/buyer is now a new client registered to system 100 and will be able to operate within system 100 with having a password and a client account number.

Similarly, should the new user/buyer utilize mobile app 346, the information provided onto screen of mobile app 346 is submitted through communication managers 554 and 754 and into client account generator module 778. The information is reviewed by an account manager/administrator of system 100. Again, should the prospective new user/buyer meet approval by the reviewer, the reviewer assigns a client account number to the prospective new user/buyer and transmits the data from new client account generator module 778 to communication manager 1054 by way of communication manager 754 and into client account table(s) 1096. The administrator will also transmit a communication from client account generator module 778 through communication manager 754 to communication manager 554 indicating to prospective user/buyer′ computing device 106. At this point, in this embodiment, step S1202 of creating a user account has been completed. The prospective new user/buyer is now a new client registered to system 100 and will be able to operate within system 100 with having a pass word and a client account number.

When the user/buyer is logging in at step S1200 and is already a registered user of system 100 and is utilizing browser 344, the user/buyer in the step of logging to user account S1203 will be provided in this embodiment, a web page from client account generator module 778 requesting a client account number and password. The user will enter its client account number and password. The password and client account number entered is transmitted to client account generator module 778 through communication managers 454 and 754. Client account generator module 778 conducts a search of client account table(s) 1096 through communication managers 754 and 1054. If the search identifies or locates a match to the provided password and client account number in client account table(s) 1096, the match is identified to client generator 778 module from the data searched in client account table(s) 1096. Client generator 778 module transmits acknowledgement of the match to the user by way of communication managers 754 and 454. This acknowledgement of a match of the client account number and password of a registered user has been located is communicated to the user by way of the web page and permission for the user/buyer is provided for them to be able to access system 100.

When the user/buyer is logging in at step S1200 and is already a registered user of system 100 and is using mobile app 346, the user/buyer in the step of logging to user account S1203 will be provided in this embodiment, a screen which asks the user/buyer to provide their account number and pass word on the screen. The user/buyer will enter its client account number and password. The password and client account number entered is transmitted to client account generator module 778 through communication managers 554 and 754. Client account generator module 778 conducts a search of client account table(s) 1096 through communication managers 754 and 1054. If the search identifies or locates a match to the provided pass word and client account number in client account table(s) 1096, the match is identified to client account generator module 778 from the data searched in client account table(s) 1096. Client account generator module 778 transmits acknowledgement of the match to the user by way of communication managers 754 and 554 to user/buyer's computing device 106. The user/buyer is now provided access to system 100.

With user/buyer logged into system 100 with use of browser 344, buyer is prompted by a web page from marketplace module 448 by way of communication manager 454. Otherwise, if user/buyer is on a computing device 106 with mobile app 346, a screen from mobile app 346 is prompting user/buyer. In either case, user/buyer is asked if they would like to conduct a query or search for a product or service and to open an exchange, or search for existing exchanges. Upon the user/buyer responding that they are interested in searching for a product or service and opening an exchange, the web page in one instance and the screen in the other instance, can provide questions that user/buyer will answer providing information regarding search parameters and mandatory matching parameters in response to the questions. In some instances all of the information requested can be required, in some instances some can be required and some can be optional, and in other instances all can be optional. Mobile exchange 562 will have, in this embodiment, some of the parameters designated as required and cannot be altered by the user. Mobile exchange 562, which in the instance of the buyer using a browser will communicate to the marketplace module 448 and through communication manager 454 to user/buyer or in the instance of the buyer using web app 346 will communicate with buyer through communication manager 554.

Mobile exchange 562 can pre-designate some parameters as required search parameters and/or required mandatory matching parameters. In instances where parameters are not pre-designated as required search or mandatory matching parameters, the buyer will be able to elect, if they so choose, whether each such parameter will be used as a search parameter for the upcoming search and/or used as a mandatory matching parameter. Mandatory matching parameters can be used by filtering and matching engine module 556 to compare the mandatory matching parameters provided against a seller's quote. The mandatory matching parameters in this step S1204 must be met or matched in order for a sale to move toward consummation, which will be discussed in more detail below. The mandatory matching parameters in step S1204 are transmitted to mobile exchange 562 and to filtering and matching engine module 556. One such search/mandatory matching parameter can, for example, be a restricted distance the product to be sold or from where the service may originate from the buyer or the buyer's computing module is before a sale can be considered to be consummated. Another example, may include a ranking the product or service must have from a third party rating system before a sale can be considered to be consummated. At step S1204, the parameters for the search and the mandatory parameters for the filtering and matching engine module 556 are received by the system. These will be further described below.

With respect to parameters designated as search parameters, some can be pre-designated by mobile exchange 562 as required and any optional ones requested could be elected by the user. The search parameters pre-designated as required, in this embodiment, can include the security ID/product description, price range, and quantity. These search parameters will be entered by the buyer from their computing device 106 and received by mobile exchange 562, either through communication manager 554 with buyer using a mobile app 346 or through communication manager 454 and marketplace 448 using browser 344.

With respect to the mandatory matching parameters, which will need to be met or matched by filtering and matching engine module 556 to move a transaction toward consummation of a sale, again some may be pre-designated by the mobile exchange 562 to be required or some of them may be designated by the user. A user will be able to select parameters not predesignated by the system as required mandatory matching parameters. Some of these mandatory matching parameters could, in this example, include price range, quantity and product/service description/security ID. As discussed above, the mandatory matching parameters could also include a parameter related to the distance between the buyer and seller, it could include a rating of the product or service, etc. These mandatory matching parameters will be entered by the user from their computing device 106 and received by mobile exchange 562 and filtering and matching engine module 556, either through communication manager 554 with buyer using a mobile app 346 or through communication manager 454 using browser 344.

With respect to selecting the parameters and entering the information in either instance of using a browser 344 or mobile app 346 the answers to the questions posed will populate a web page in the first instance and data will be displayed on a screen with mobile app 346 on computing device 106. One question prompted to the user/buyer could include identifying the product or service user/buyer wishes to purchase. The user/buyer could then provide a written description of the product or service for step S1204. In the instance of using browser 344, the written description will be transmitted to the quote handler module 664 quote handler module 664 by way of communication managers 454 and 654. If mobile app 346 is used, the computing device communicates through communication manager 554 to communication manager 654 to quote handler module 664 quote handler module 664. Quote handler module 664 quote handler module 664 will, in turn, search security ID table(s) 1094. The results of the search will be retransmitted back to user/buyer through quote handler module 664 quote handler module 664 to marketplace module 448 to communication manager 454 and displayed on web page of user/buyer. It is possible several or more results may be transmitted to user/buyer and user/buyer can select one of the results presented which then provides a security ID for that item selected. Similarly, the search results are sent from quote handler module 664 quote handler module 664 to mobile exchange 562 by way of communication managers 654 and 554. The results are sent to computing device 106 by way of communication manager 554 and the choices are provided to user/buyer on the screen of computing device 106. These results are presented to the buyer user and they can then select the correct item thereby entering the proper security ID for that particular product. The security ID is now usable for not only the search parameters but also for the mandatory matching parameter(s) for step S1204.

Additional questions presented to user/buyer, for answers to be received in step S1204, whether on a web page or screen, could include location of the user/buyer. In the instance of using a browser 344, user/buyer may input an address location and in the instance of using a mobile app 346, a GPS 341 device on the computing device 106 can provide the computing device 106 location. This location information, in this embodiment, is designated as both a search and mandatory matching parameter. Other parameters for searching and for matching can, for the present embodiment, include the quantity the user/buyer is interested in purchasing and that can be entered by user/buyer either into the web page or the screen and provided to mobile exchange 562, as well as the price range that was acceptable to user/buyer. In step S1206, the step of opening an exchange can include submitting the information or parameters in step S1204, discussed above, to exchange table(s) 1102 and sending the mandatory matching parameters to filtering and matching module 556. In the instance of submission of the information entered into the web page provided user/buyer with use of browser 344, the information is communicated to communication manager 454 to and to marketplace module 448 and to communication manager 1054 and written onto exchange table(s) 1102 and to communication manager 554 to mobile exchange 562. With respect to using a mobile app 346 the information that was provided by the user/buyer on the screen is communicated to communication manager 554 and to mobile exchange 562. The information is then transmitted through communication manager 554 to communication manager 1054 and is uploaded into exchange table(s) 1102. Additional data may also be uploaded into exchange table(s) 1102 such as the client ID which originated from the logging in of that particular user/buyer which also identifies the one logging in as a buyer or seller. The exchange table(s) 1102 can also, assign an Exchange ID number with each exchange that is opened. At this point, an exchange is open in mobile exchange 562 and is in exchange table(s) 1102.

At step S1208, the search or query is commenced by the mobile exchange 562 with the user/buyer using mobile app 346 and commenced by marketplace module 448 with user/buyer using browser 344. The search or query in this embodiment will include the information or parameters discussed above that were entered into exchange table(s) 1102. Thus, the security ID of the product or service, the quantity, location of the buyer, the acceptable price range for the user/buyer and the distance restriction for the product or service to be located from the buyer, etc., can be transmitted as the query or search parameters.

In running the search/query, the parameters are transmitted by either the marketplace module 448 or by mobile exchange 562, depending if the user/buyer is operating with a browser 344 or mobile app 346, respectively. The parameters are communicated with communication managers 454 and 654 from marketplace module 448 to quote handler module 664 with respect to operating with a web browser 344 and communicated from mobile exchange 562 by way of communication managers 554 and 654 to quote handler module 664. The quote handler module 664 in either instance will conduct a search with these parameters in quote table(s) 1090 and exchange table(s) 1102 to locate matches. In step S1210, the matching search results are transmitted by quote handler module 664 through communications managers 654 and 454 to the web page on computing device 106 that is using browser 344, or through communication manager 554 to mobile exchange 562 and through to communication manager 1054 where the results are saved to exchange table(s) 1102. On the other hand, the matching search results are transmitted by quote handler module 664 through communications managers 654 and 554 to the screen to the mobile exchange 562 and to mobile app 346 on computing device 106 that is using mobile app 346, as well as to communication manager 1054 where the results are saved to exchange table(s) 1102.

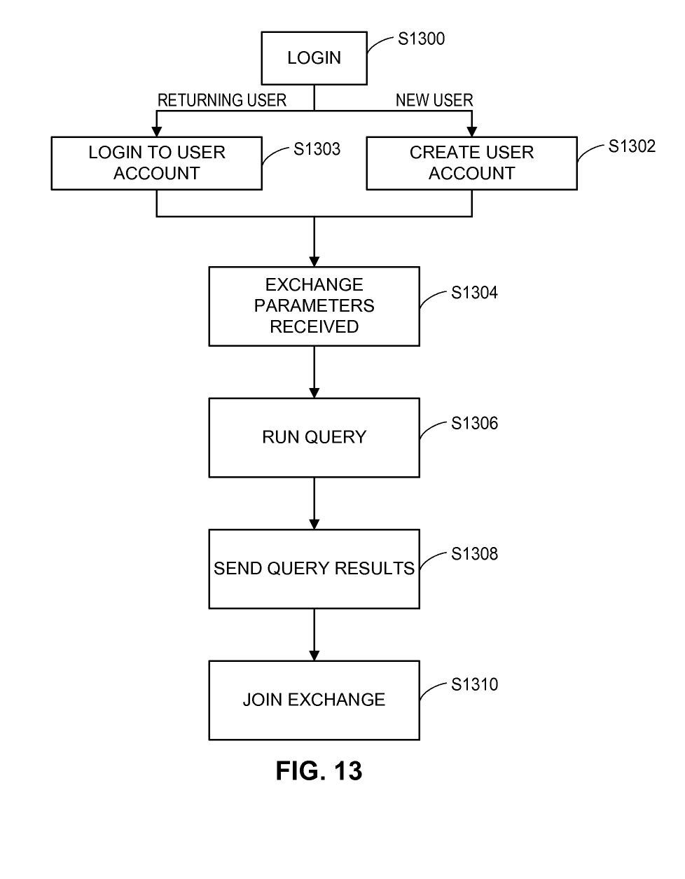

Referring to FIG. 13, an example method for searching and joining an already opened exchange is shown. This method can apply to both sellers and buyers of system 100. For purposes of the description below, buyers and sellers are referred to collectively as “users”. Initially, a user must log into system 100. As described above, a user logs into system 100 either creates a new account or otherwise logs into a previously created user account as described above for steps S1100, S1102 and S1103 (sellers) and S1200, S1202 and S1203 (buyers), which are the same steps which correspond to steps S1300, S1302 and S1303, respectively, of FIG. 13.

Once logged into system 100, at step S1304, a user using a browser 244 or 344 or mobile app 346 will set forth exchange parameters that they want system 100 to use in searching for open exchanges. The user is prompted by a web page from marketplace module 448 by way of communication manager 454 or by a screen from mobile app 346 if they would like to conduct a query or search for a product or service and open exchange or search for existing exchanges. Upon the user responding that they are interested in searching for existing exchanges, the web page or screen will provide the user questions requesting information required to commence searching for existing exchanges in exchange table(s) 1102. Marketplace module 448/mobile exchange 562 can use the information provided by the user to search exchange table(S) 1102 for open exchanges that match the information are return the search results to the user. Based on the search results, the user can scroll through the open exchanges and select an open exchange. Upon selecting an exchange, the user can be displayed the mandatory matching parameters set for the exchange. They can also be displayed any current open bids and offers that exist in that exchange. If the user decides to join the exchange, they can interact in the exchange the same way they would interact with an exchange the user created.

The questions presented to the user can include identifying the product/service, seller, other user, or any other parameter the user wishes to use to locate an open exchange. Should the user not already have the security ID for the product or service in which they are interested, the seller ID for the particular seller, the user ID for the particular user, or any other parameter, the user can provide a written description of the product/service, seller, other user, or other parameter. System 100 can then search for open exchanges in exchange table(s) 1102 using the written description entered by the user through marketplace 448 or mobile exchange 562 or can locate a specific product or service using quote table(s) 1090. If the system is set up to identify a specific product/service, the written description can be transmitted to quote handler module 664, which can search quote table(s) 1090 for specific security IDs that match the description entered by the user. Alternatively, quote handler module 664 could also search security ID table(s) 1094. The results of the search will be retransmitted back to the user through quote handler module 664 and marketplace module 448/mobile exchange 562 and displayed to the user. The user can then select one of the results presented which then provides a security ID for that item selected.

In step S1306, a query or search for open exchanges is commenced by mobile exchange 562 using the parameters discussed above. In running the query or search, marketplace module 448/mobile exchange module 562 forward the search request and parameters to exchange table(s) 1102, which identify open exchanges that match the parameters and matching search results are transmitted back to marketplace module 448/mobile exchange 562. At step S1308, the search results are sent from marketplace module 448/mobile exchange 562 to the user. The search results displayed to the user can include various information, such as, the original search parameters, mandatory matching parameters for the exchanges identified, seller(s) and buyer(s) active in the exchanges, offers and counteroffers, etc.

At step S1310, the user joins one of the exchanges identified in the search results. To join an open exchange, user can select an open exchange from the search results presented by accessing mobile exchange 562 through either marketplace module 448 or mobile app 346 and indicating that the user has chosen to enter the exchange. The user ID is then added to the open exchange in mobile exchange 562 into the exchange table(s) 1102. The user can then interact with the selected exchange just as they would interact with an exchange they opened.

Alternatively, open exchanges could be joined in other manners as well. For example, a user could receive an invitation from another user and select a link in the communication to join the exchange. In addition, a user could receive an advertisement and click on a link to join an exchange identified in the advertisement.

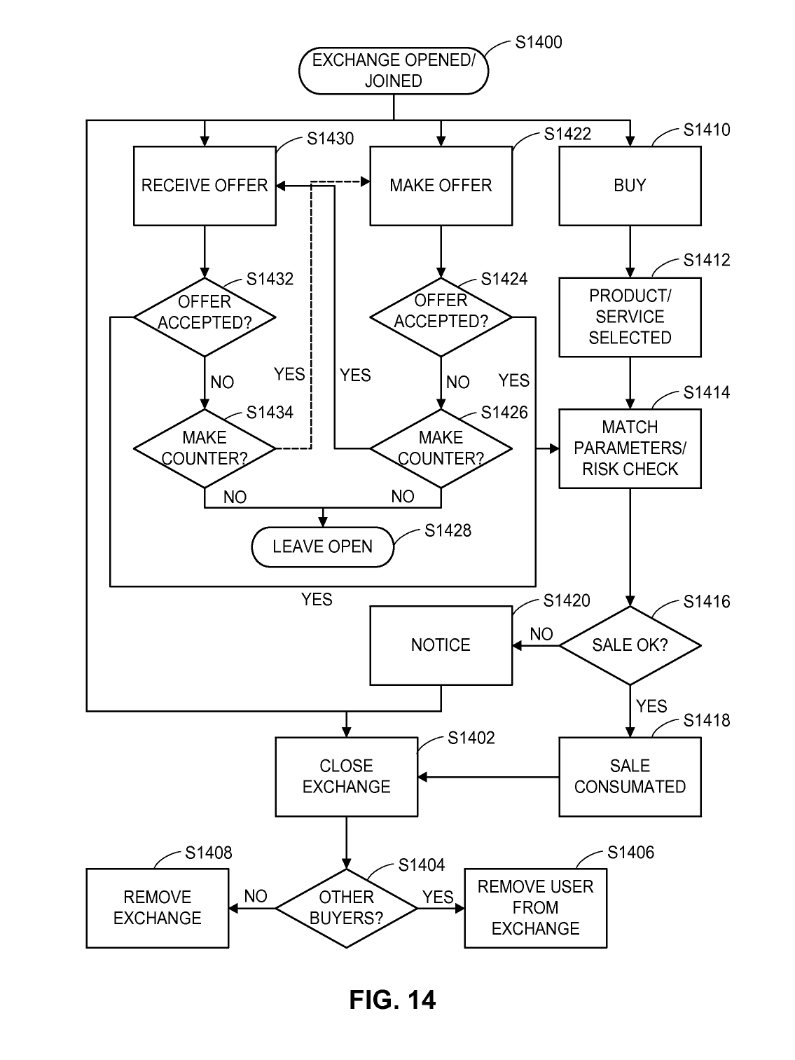

Referring to FIG. 14, a method for purchasing a product/service from a buyer set up exchange is shown. As used herein, a buyer set up exchange could be a buyer creating its own exchange, as described above and shown in FIG. 12, or a buyer joining an open exchange, as described above and shown in FIG. 13. Step S1400 shows the buyer opening or joining an exchange.

Once a buyer is in an exchange, by either creating or joining it, the buyer has multiple choices. At step S1402, the buyer could decide that it wants to close out of the exchange. This could be from an exchange they created or one they located and joined. At that point, the buyer indicates that they wish to close out of that exchange and that instruction goes through marketplace module 448 to mobile exchange 562. At step 1404, mobile exchange 562 checks to see if other buyers are still in that exchange. If the answer is “yes,” mobile exchange 562 removes the buyer from the open exchange in exchange table(s) 1102, as seen as step S1406, and the exchange is left open until all users are removed from the exchange. If there answer is “no,” mobile exchange 562 removes that exchange from the exchange table(s) 1102, as seen as step S1408. A removed exchange could be archived by system 100.

At step S1410, the buyer may decide to buy a product or service that is in the open exchange. At this point, the buyer will be able to select a product or service to purchase in the open exchange and this information is received by the marketplace module 448/mobile exchange 562 at step S1412. Once the product or service to purchase has been selected, mobile exchange 562 communicates the buyer's order to risk calculator module 886 on risk server 120 and to filtering and matching engine module 556.

At step S1414, the filtering and matching engine module 556 matches the buyer's order against the seller's quote for the mandatory matching parameters set when the exchange was created. In addition, the risk calculator module 886 checks to see if the order meets a set of predetermined risk parameters, as discussed above. The risk calculator module 886 is used to limit the risk of mistakes and theft within the operation of system 100. Risk calculator modules are well known and can be used to attempt to prevent a consummation of a sale should a “fat finger” event take place, possibly generating too large of orders. The risk calculator module 886 may for example, limit total number of purchases or total dollar amount of purchases of a buyer for a day or other time period in the interest of limiting negligent or fraudulent activity.

At step S1416, it is determined if the sale is satisfactory to make or not based on the results of the parameter matching and risk check. If a match has occurred with respect to the mandatory matching parameters within filtering and matching engine module 556 and the risk parameters are satisfied within risk calculator module 886, the results are communicated from the risk calculator module 886 and filtering and matching engine module 556 to the clearinghouse server 118. These communications from risk calculator module 886 and filtering and matching engine module 556 are communicated to fill generator module 774, which consummates the sale at step S1418. Fill generator module 774 communicates to client account generator module 778 that the transaction has been authorized and the instructions are sent by client account generator module 778 that a certain amount of money is to be charged or debited to the buyer's credit card account to pay for the purchase. The seller is credited the sales amount to the seller's account through communication generator 754. A commission can be retained for the administration account for use of system 100. Once the appropriate accounts have been debited and credited for the sale, the client account generator module 778 instructs fill generator module 774 to instruct through communication managers 754 and 454 to ledger and transactions module 450 the sale has been made thereby notifying the seller through ledger and transactions module 450 of the sale, the pending delivery, pick-up, etc., of the product or service purchased. The fill generator module 774 also communicates this transaction was consummated to client account table(s) 1096 and filled order table(s) 1098 through communication managers 754 and 1054. Fill generator module 774 also communicates to marketplace module 448/mobile exchange 562 indicating the sale is complete and in turn marketplace module 448/mobile exchange 562 communicates to buyer computing device 106 the sale has been completed.

At step S1402, it is determined whether or not to close the exchange, as described above. At step S1404, it is determined if there are other buyers in the exchange. If the answer is “yes,” the buyer who completed the above described purchase is removed from the exchange in exchange table(s) 1102 at step S1206. If the answer is “no”, the exchange is removed from exchange table(s) 1102 at step S1408, as described above for steps S1404, S1406 and S1408.

However, if the risk is checked and all mandatory matching parameters are checked at step S1414 and the evaluation is determined at step S1416 to be “no”, that the risk was not satisfactory and/or all mandatory matching parameters could not be matched, the process continues with step S1420 and a rejection notice is issued by risk calculator module 886 and/or filtering and matching engine module 556 that the transaction cannot be consummated and the process continues with step S1402. This notice can be issued from risk calculator module 886 and/or filtering matching engine module 556 to mobile exchange 562, and mobile exchange 562 can communicate this rejection notice to computing device 106 through marketplace module 448 or mobile app 346. With this notice to mobile exchange 562, mobile exchange 562 continues with step S1402 and closes the open exchange.

The buyer also has another choice when an exchange has been created or entered at step S1400. The buyer could review the quotes in the exchange and decide not to accept any of the sellers' offers, but will make an offer that does not match existing seller offers in the exchange, as shown in step S1422. The offer is transmitted by buyer by way of marketplace module 448/mobile exchange 562, which then enters the offer onto exchange table(s) 1102 on database server 124.

Seller can view the open exchange through marketplace module 448 with the use of computing device 108. Seller can check which open exchanges it is in through accessing ledger and transaction module 450 with computing device 108 through communications manager 454. When provided the exchange identification in the transaction and ledgers module 450, seller can access through marketplace module 448 the mobile exchange 562 on mobile exchange server 112. The seller could also locate the open exchange through conducting a search for an open exchange as described above.

With seller in position to observe buyer's offer in the open exchange, at step S1424 it is determined whether the offer is accepted by the seller. If the answer is “yes”, mobile exchange 562 receives the acceptance from marketplace module 448 and communicates that the transaction has been accepted to risk calculator module 886 and to filtering and matching engine module 556 to check if mandatory parameters have been matched, at step S1414 and the process continues as described above.

However, if the answer is “no” at step S1424, at step S1426 the seller can make a counter to the offer originally made in step S1422 by the buyer. If the answer is “no”, the seller does not want to make a counter offer, the open exchange remains open at step S1428. If the answer is “yes”, the seller does want to make a counter offer, the seller enters a counter through marketplace module 448 to the open exchange in mobile exchange 562, which is entered by mobile exchange 562 into exchange table(s) 1102. The process then continues with step S1430, wherein the buyer receives offer.

At step S1430, the buyer could also receive an offer from a seller without having had initiated an offer at step S1422. Thus, at step S1430, regardless of whether the offer came from a counteroffer of seller or was originated by a seller through marketplace module 448, the next step is for the buyer to decide whether they wish to accept the received offer in step S1432. If the answer is “yes”, marketplace module 448/mobile exchange 562 notifies risk calculator module 886 and matching and filtering engine module 556 that this has occurred and the process continues with step S1414, as described above. If the answer is “no”, at step S1434 it is decided if the buyer will make a counter offer. If the answer is “no”, the exchange remains open at step S1428. If the answer is “yes”, the buyer through the communicating with the marketplace 448/mobile exchange 562, makes a counter offer to the seller's offer of step S1430, which is received by mobile exchange 562 and transmitted to exchange table(s) 1102 and the process continues with step S1422, as described above. The process of offers and counter offers can go on until a sale is consummated, the exchange is left open, or the buyer decides to close the exchange.

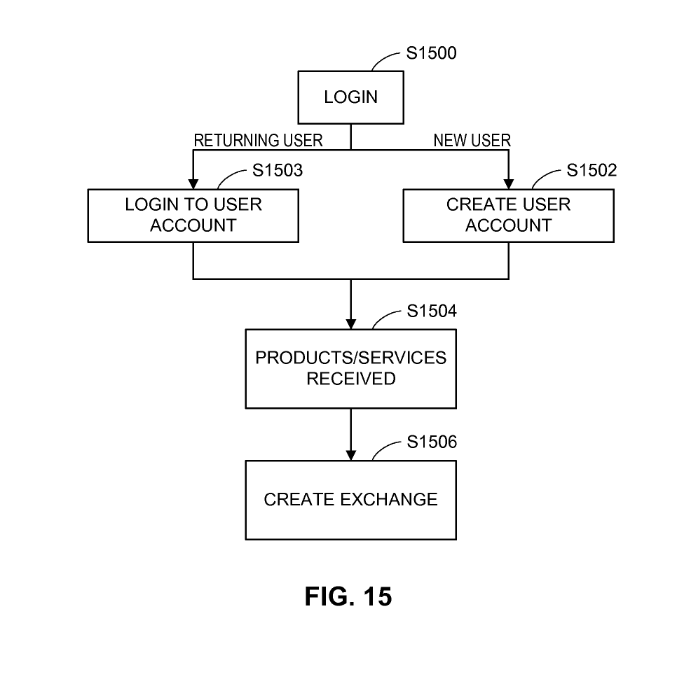

Referring to FIG. 15, a method for a seller to create an exchange is shown. Initially the seller logs in at step S1500. If the seller is a new user, the seller will go through step S1502 and if the seller is a returning user, the seller will go through step S1503. The procedure of logging in at steps S1500, S1502, and S1503 are the same as have been described above for FIG. 11 wherein steps S1100, S1102 and S1103 correspond to the steps herein of S1500, S1502 and S1503, respectively.

Once seller has successfully logged into system 100, marketplace module 448 can provide the seller the option of opening an exchange. If the seller wants to open an exchange, at step S1504, marketplace module 448 will ask the seller to provide data regarding products or services the seller wants to list in the exchange. The data requested by marketplace module 448 can be the same as the data for the quote table(s) 1090, as has been described earlier. The product/service could be an item that has already been entered by the seller in the quote table(s) 1090, for example, when uploading its quotes through storefront module 452, in which case the seller will select the products/services from the data from quote table(s) 1090.

If the seller has not already entered the product/service information in quote table(s) 1090, the seller will be asked to provide the data needed for an item to be listed in quote table(s) 1090, as discussed above. As described above, this information can include: a security identification number that identifies the particular product/service; a text description of the product/service; the quoted price for the product/service; the location of the store of the seller and the quantity of the product/service that is available for sale, etc. In addition to providing the information above for the product/service, the seller will also be required to indicate with parameters will be mandatory matching parameters for a sale to take place, such as distance of buyer from seller, price range, and quantity. With the data requested for the item to be listed, along with the mandatory matching parameters information, being provided by the seller, the new exchange is opened at step S1506. In step S1506, mobile exchange 562 can send the product/service information and mandatory matching parameters to exchange table(s) 1102 and the mandatory matching parameters to filtering and matching engine module 556.

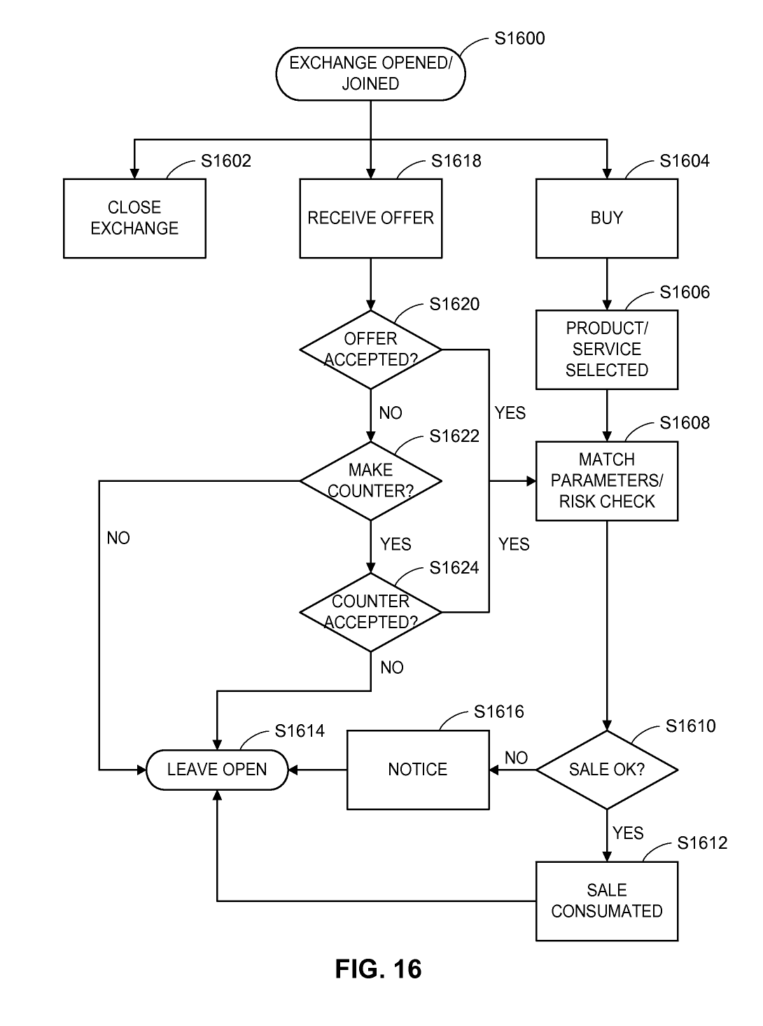

In referring to FIG. 16, a method for purchasing a product/service from a seller set up exchange is shown. At step S1600, an exchange is opened by a seller, as described above and shown in FIG. 15, or an exchange opened by a seller is joined by a user, as described above and shown in FIG. 13.

Once an exchange has been opened/joined, there are various actions that can occur. At step S1602, the seller that created the exchange can choose to close the exchange, in which case mobile exchange 562 will receive the instruction from the seller through marketplace module 448 and remove the exchange from exchange table(s) 1102.

At step S1604, a buyer can decide to purchase one of the products/services included in the exchange as the product/service is listed. At step S1606, the products/services to be purchased are selected. The buyer could view the open exchange through computing device 106 either by way of mobile app 346 or through browser 344. The buyer can send an instruction to buy a listed item, which can be received by marketplace 448/mobile exchange 562.

Once a buy instruction has been received, at step S1608, the mandatory matching parameters are checked and the risk is analyzed, as described above for step S1414.

As described above, mobile exchange 562 communicates the offer to risk calculator module 886 for risk evaluation and to filtering and matching engine module 556 for comparison of the mandatory matching parameters. At step S1610, risk calculator module 886 and filtering and matching engine module 556 determine if the sale is approved, as described above in step S1416. If the risk calculator module 886 determines the risk to be satisfactory and filtering and matching engine module 556 determines that the mandatory matching parameters are satisfied, the process proceeds with step S1612. If the risk calculator module 886 determines the risk to be unsatisfactory and/or the filtering and matching engine module 556 determines that one or more the mandatory matching parameters are not satisfied, the process proceeds with step S1616.

At step S1612, the approvals are communicated from risk calculator module 886 and filtering and matching engine module 556 to fill generator module 774, indicating the transaction is authorized to be consummate. Fill generator module 774 communicates to client account generator module 778 that the transaction has been authorized and the instructions are sent by client account generator module 778 that a certain amount of money is to be charged or debited to the buyer's account to pay for the purchase. The seller is also credited the sales amount to the seller's account through communication generator 754. A commission can also be retained for the administration account for use of system 100. Once the accounts have been debited and credited for the sale, the client account generator module 778 instructs fill generator module 774 to instruct ledger and transactions 450 module that the sale has been made, thereby notifying the seller through ledger and transactions module 450 of the sale, the pending delivery, pick-up, etc., of the product or service purchased. The fill generator module 774 also communicates the consummated transaction to client account table(s) 1096 and filled order table(s) 1098 through communication managers 754 and 1054. Fill generator module 774 also communicates to mobile exchange 562 that the quantity purchased for the item(s) purchased need to be reduced and mobile exchange 562 communicates to exchange table(s) 1102 to reduce the quantity of items purchased for that exchange. Fill generator module 774 also communicates to mobile exchange 562 and in turn to mobile app 364 or mobile exchange 562 to marketplace module 448 to buyer computing device 106, indicating the sale is complete.

With the consummation of the sale at step S1612, at the process continues with step S1614, where the exchange is left open. If all of the product/services offered for sale by the seller in the exchange are depleted, the exchange will remain open until the seller offer additional products/services through the exchange or closes the exchange.

At step S1616, a rejection notice is issued by risk calculator module 886 and/or filtering and matching engine module 556 that the transaction cannot be consummated. This notice is issued from risk calculator module 886 and/or filtering matching engine module 556 to mobile exchange 562, which communicates the rejection notice to marketplace module 448 and then to computing device 106, or to mobile app 346 on computing device 106, which communicates to the buyer depending on the buyer's use of browser 344 or mobile app 346. Once the rejection notice issued at step S1616, the exchange is left open at step S1614.

At step S1618, the seller can also receive an offer from a buyer. A buyer that has joined the exchange can decide to make an offer to the seller that is currently different from the seller's position, for example, a different price. The buyer communicates the offer through its computing device 106 using mobile app 346 or browser 344 through the mobile exchange 562/marketplace module 448. The mobile exchange 562 communicates the offer to the exchange table(s) 1102 and the offer can be seen by the seller through marketplace module 448.

When an offer from a buyer has been received, at step S1620 the seller could decide to accept or reject the buyer's offer. If the seller accepts the offer, seller communicates this acceptance through marketplace module 448 to mobile exchange 562 and the process continues with step S1608, as described above. If the seller rejects the offer, seller communicates this rejection through marketplace module 448 to mobile exchange 562 and the process continues with step S1622.

At step S1622, the seller decides if it will make a counteroffer. If the seller does not make a counter offer, the process continues with step S1614, wherein the exchange remains open. However, if the seller decides to make a counter offer, the counter offer is communicated through marketplace module 448 to mobile exchange 562 and is saved into the open exchange and is written into the exchange at exchange table(s) 1102 and the process continues with step S1624.

At step 1624, it is determined if the buyer accepts the counter offer. If the counter offer is not accepted, the method proceeds to step S1614 and the exchange is left open. However, if the counter offer is accepted by the buyer, the acceptance is recorded in exchange table(s) 1102 and the method proceeds to step S1608, as described above.

System 100 can also provide a seller the ability to conduct analytical studies of data contained within system 100. These analytical studies can be conducted by seller through marketplace module 448. In one example, a seller may be able to search for how many of a particular product or service has been sold in a certain region. This communication by seller would include providing information, such as a security ID/product description, a distance from a given location, etc. The parameters can be sent from marketplace module 448 to fill generator module 774 to perform the search. Fill generator module 774 can transmit the results back to the marketplace module 448, which would display the search results to the seller. Similarly an analytical search by seller could include the request for the average execution price of a particular product/service by region over time. These parameters could be forwarded by seller to fill generator module 774 and the results could be transmitted back to marketplace module 448 for access by seller.

The seller that is a member to system 100 may choose to perform research or studies within system 100. For example, seller may choose to see the number of transactions for a particular product or service has occurred within a certain geographic area. Seller will access marketplace module 448 from its computing device 108. The web page will provide the seller the option to conduct an analytical search within system 100. The seller can provide the security ID for the product or service and the geographical range from the seller's location, for example, and submit this search information. Marketplace module 448 will transmit the search request by way of the communication manager 454 to communication manager 1054. The search will then be submitted into filled orders table(s) 1098, The results of this search will be transmitted from the filled orders table(s) 1098 back through communication managers 1054 and 454 to marketplace module 448. The seller will view the analytical search results from marketplace module 448. This similarly can be done for other analytical searches such as, searching for the number of transactions for a particular product or service by a region over time. The time frame information would be entered at marketplace module 448 along with the security ID and the geographic area to be searched. The search will be conducted with filled orders table(s) 1098 and communicated back to marketplace module 448 to be viewed by the seller.

Other analytical searches such as finding the average price of a particular product or service within a particular geographic region or even the same search over a period of time, can be conducted in the same fashion as described above. The information, the request for price of a particular product or service that was sold that had a particular security ID and was sold in a particular geographic region, would be submitted into marketplace module 448. If a period of time was a search criteria that could be added into the search information at that time. Again, the search is sent to filled orders table(s) 1098 and conducted therein. The results are sent back to marketplace module 448 for the seller to view. The marketplace module 448 will take the number of transactions and their prices, for this search analysis and calculate the average price for the seller for the particular region requested and for a time frame, if requested.

1. A method, comprising the steps of:
receiving a plurality of search parameters through a network interface from a user computing device, the search parameters comprising an inventory item description, a price range, a location, and a distance range from the location;
performing a search, via a processor, in a quote table stored in a memory for inventory items that meet the search parameters and retrieving a set of search results, the search results comprising at least one inventory item security identifier, a corresponding sale price, and a corresponding sale location;
setting up an individual exchange in an exchange table each time a search is performed, each individual exchange being searchable and accessible by other users;
storing the search results and the plurality of search parameters in the individual exchange in the exchange table stored in the memory; and
sending the search results through the network interface to the user computing device.

2. The method of claim 1, further comprising the step of performing a search, via the processor, in a security identification table stored in the memory for a security identification identifier associated with the inventory item description.

3. The method of claim 1, further comprising the steps of:
receiving inventory item information from a seller computing device through the network interface, the inventory item information comprising a sale price, a sale location, and at least one of an inventory item description and an inventory item security identifier; and
saving the inventory item information into the quote table stored in the memory.

4. The method of claim 3, wherein the inventory item information further comprises at least one of an available quantity, a text description, a third party rating, and a duration of the sale price.

5. The method of claim 3, wherein the security identifier comprises a bar code number from a Universal Product Code.

6. (canceled)

7. The method of claim 1, further comprising the steps of:
receiving at least one matching parameter through the network interface from the user computing device, wherein the matching parameter must be matched in order to make a consummation of a purchase possible; and
saving the at least one matching parameter in the exchange table stored in the memory.

8. The method of claim 7, further comprising the steps of:
receiving a purchase instruction through the network interface from the user computing device, the purchase instruction including an indication of a purchase decision for an inventory item identified in the search results;
determining, via the processor, if the inventory item information included in the purchase instruction matches the at least one matching parameter stored in the exchange table;
determining a sale risk, via the processor, if the inventory item information included in the purchase instruction does match the at least one matching parameter stored in the exchange table, the sale risk indicating if a user has exceeded a predetermined purchase limit; and
consummating the sale if the user has not exceed the predetermined purchase limit.

9. The method of claim 8, further comprising the steps of:
sending a first notification through the network interface to the user computing device if the inventory item information included in the purchase instruction does not match the at least one matching parameter stored in the exchange table, the first notification comprising a notice that the purchase cannot be consummated; and
sending a second notification through the network interface to the user computing device if the user has exceeded the predetermined purchase limit, the second notification comprising a notice that the purchase cannot be consummated.

10. The method of claim 7, further comprising the steps of:
receiving an offer through the network interface from one of the seller computing device and the user computing device for an inventory item identified in the search results;
saving the offer in the exchange table in the memory;
receiving an acceptance through the network interface from the other of the seller computing device and the user computing device, the acceptance including an indication that the offer has been accepted;
determining, via the processor, if the inventory item information for the inventory item associated with the offer and acceptance matches the at least one matching parameter stored in the exchange table;
determining a sale risk, via the processor, if the inventory item information for the inventory item associated with the offer and acceptance matches the at least one matching parameter stored in the exchange table, the sale risk indicating if a user has exceeded a predetermined purchase limit; and
consummating the sale if the user has not exceed the predetermined purchase limit.

11. The method of claim 10, further comprising the steps of:
sending a first notification through the network interface to the user computing device if the inventory item information for the inventory item associated with the offer and acceptance does not match the at least one matching parameter stored in the exchange table, the first notification comprising a notice that the purchase cannot be consummated; and
sending a second notification through the network interface to the user computing device if the user has exceeded the predetermined purchase limit, the second notification comprising a notice that the purchase cannot be consummated.

12. The method of claim 7, further comprising the steps of:
receiving an offer through the network interface from one of the seller computing device and the user computing device for an inventory item identified in the search results;
saving the offer in the exchange table in the memory;
receiving a counteroffer through the network interface from the other of the user computing device and the seller computing device for the inventory item; and
receiving at least one of an acceptance and another counteroffer through the network interface from the one of the seller computing device and user computing device for the inventory item.

13. The method of claim 12, further comprising the steps of:
determining, via the processor, if the inventory item information for the inventory item matches the at least one matching parameter stored in the exchange table, if the acceptance is received from the one of the seller computing device and user computing device;
determining a sale risk, via the processor, if the inventory item information for the inventory item matches the at least one matching parameter stored in the exchange table, the sale risk indicating if a user has exceeded a predetermined purchase limit; and
consummating the sale if the user has not exceed the predetermined purchase limit.

14. The method of claim 13, further comprising the steps of:
sending a first notification through the network interface to the user computing device if the inventory item information for the inventory item does not match the at least one matching parameter stored in the exchange table, the first notification comprising a notice that the purchase cannot be consummated; and
sending a second notification through the network interface to the user computing device if the user has exceeded the predetermined purchase limit, the second notification comprising a notice that the purchase cannot be consummated.

15. The method of claim 1 wherein the location is determined by a global positioning system receiver of the user computing device.

16. A system, comprising:
a processor;
a memory connected to and in communication with the processor; and
a network interface connected to and in communication with the processor; wherein
the memory comprises a plurality of computer executable instructions stored therein that, in response to execution by the processor, perform the steps of:
receiving a plurality of search parameters through the network interface from a user computing device, the search parameters comprising an inventory item description, a price range, a location, and a distance range from the location;
performing a search in a quote table stored in a memory for inventory items that meet the search parameters, and retrieving a set of search results, the search results comprising at least one inventory item security identifier, a corresponding sale price, and a corresponding sale location;
setting up an individual exchange in an exchange table each time a search is performed, each individual exchange being searchable and accessible by other users;
storing the search results and the plurality of search parameters in the individual exchange in the exchange table stored in the memory; and
sending the search results through the network interface to the user computing device.

17. The system of claim 16, wherein the computer executable instructions, when executed by the processor, further perform the steps of performing a search in a security identification table stored in the memory for a security identification identifier associated with the inventory item description.

18. The system of claim 16, wherein the computer executable instructions, when executed by the processor, further perform the steps of:
receiving inventory item information from a seller computing device through the network interface, the inventory item information comprising a sale price, a sale location, and at least one of an inventory item description and an inventory item security identifier; and
saving the inventory item information into the quote table stored in the memory.

19. The system of claim 18, wherein the inventory item information further comprises at least one of an available quantity, a text description, a third party rating, and a duration of the sale price.

20. The system of claim 18, wherein the security identifier comprises a bar code number from a Universal Product Code.

21. (canceled)

22. The system of claim 16, wherein the computer executable instructions, when executed by the processor, further perform the steps of:
receiving at least one matching parameter through the network interface from the user computing device, wherein the matching parameter must be matched in order to make a consummation of a purchase possible; and
saving the at least one matching parameter in the exchange table stored in the memory.

23. The system of claim 22, wherein the computer executable instructions, when executed by the processor, further perform the steps of:
receiving a purchase instruction through the network interface from the user computing device, the purchase instruction including an indication of a purchase decision for an inventory item identified in the search results;
determining if the inventory item information included in the purchase instruction matches the at least one matching parameter stored in the exchange table;
determining a sale risk if the inventory item information included in the purchase instruction does match the at least one matching parameter stored in the exchange table, the sale risk indicating if a user has exceeded a predetermined purchase limit; and
consummating the sale if the user has not exceed the predetermined purchase limit.

24. The system of claim 23, wherein the computer executable instructions, when executed by the processor, further perform the steps of:
sending a first notification through the network interface to the user computing device if the inventory item information included in the purchase instruction does not match the at least one matching parameter stored in the exchange table, the first notification comprising a notice that the purchase cannot be consummated; and
sending a second notification through the network interface to the user computing device if the user has exceeded the predetermined purchase limit, the second notification comprising a notice that the purchase cannot be consummated.

25. The system of claim 22, wherein the computer executable instructions, when executed by the processor, further perform the steps of:
receiving an offer through the network interface from one of the seller computing device and the user computing device for an inventory item identified in the search results;
saving the offer in the exchange table in the memory;
receiving an acceptance through the network interface from the other of the seller computing device and the user computing device, the acceptance including an indication that the offer has been accepted;
determining if the inventory item information for the inventory item associated with the offer and acceptance matches the at least one matching parameter stored in the exchange table;
determining a sale risk if the inventory item information for the inventory item associated with the offer and acceptance matches the at least one matching parameter stored in the exchange table, the sale risk indicating if a user has exceeded a predetermined purchase limit; and
consummating the sale if the user has not exceed the predetermined purchase limit.

26. The system of claim 25 wherein the computer executable instructions, when executed by the processor, further perform the steps of:
sending a first notification through the network interface to the user computing device if the inventory item information for the inventory item associated with the offer and acceptance does not match the at least one matching parameter stored in the exchange table, the first notification comprising a notice that the purchase cannot be consummated; and
sending a second notification through the network interface to the user computing device if the user has exceeded the predetermined purchase limit, the second notification comprising a notice that the purchase cannot be consummated.

27. The system of claim 22, wherein the computer executable instructions, when executed by the processor, further perform the steps of:
receiving an offer through the network interface from one of the seller computing device and the user computing device for an inventory item identified in the search results;
saving the offer in the exchange table in the memory;
receiving a counteroffer through the network interface from the other of the user computing device and the seller computing device for the inventory item; and
receiving at least one of an acceptance and another counteroffer through the network interface from the one of the seller computing device and the user computing device for the inventory item.

28. The system of claim 27, wherein the computer executable instructions, when executed by the processor, further perform the steps of:
determining if the inventory item information for the inventory item matches the at least one matching parameter stored in the exchange table if the acceptance is received from the one of the seller computing device and user computing device;
determining a sale risk if the inventory item information for the inventory item matches the at least one matching parameter stored in the exchange table, the sale risk indicating if a user has exceeded a predetermined purchase limit; and
consummating the sale if the user has not exceed the predetermined purchase limit.

29. The system of claim 28, wherein the computer executable instructions, when executed by the processor, further perform the steps of:
sending a first notification through the network interface to the user computing device if the inventory item information for the inventory item does not match the at least one matching parameter stored in the exchange table, the first notification comprising a notice that the purchase cannot be consummated; and
sending a second notification through the network interface to the user computing device if the user has exceeded the predetermined purchase limit, the second notification comprising a notice that the purchase cannot be consummated.

30. The system of claim 16, wherein the location is determined from a global positioning system receiver of the user computing device.
